(19) United States
(12) Patent Application Publication
(10) Pub. No.: US 2024/0345328 A1
(43) Pub. Date: Oct. 17, 2024

(54) RECEPTION DEVICE AND COMMUNICATION DEVICE

(71) Applicant: NEC Corporation, Minato-ku, Tokyo (JP)

(72) Inventors: Koya TAKATA, Tokyo (JP); Hisashi MIZUMOTO, Tokyo (JP); Fujio OKUMURA, Kanagawa (JP)

(73) Assignee: NEC Corporation, Minato-ku, Tokyo (JP)

(21) Appl. No.: 18/683,295

(22) PCT Filed: Aug. 27, 2021
(86) PCT No.: PCT/JP2021/031472

§ 371 Date: Feb. 13, 2024

(51) Int. Cl. G02B 6/32; G02B 6/42; H04B 10/67

(52) U.S. Cl. CPC G02B 6/32; G02B 6/4246; H04B 10/671

(57) ABSTRACT

A reception device that includes a ball lens that collects an optical signal propagating in a space, a light receiving element array that includes a plurality of light receiving elements that each receive the optical signal collected by the ball lens and outputs a signal derived from the optical signal received by each of the plurality of light receiving elements, and a reception circuit that decodes the signal output from the light receiving element array.

### TECHNICAL FIELD

The present disclosure relates to a reception device or the like that receives an optical signal propagating in a space.

### BACKGROUND ART

In optical space communication, an optical signal (hereinafter, also referred to as a spatial optical signal) propagating in a space is transmitted and received without using a medium such as an optical fiber. In order to receive a spatial optical signal propagating in a wide space, it is preferable to use a lens having as large a diameter as possible. For optical space communication, a light receiving element having a small capacitance is adopted in order to perform high-speed communication. Such a light receiving element has a small light receiving portion. Since a focal length of the lens is limited, it is difficult to guide spatial optical signals arriving from various directions to the small light receiving portion by using the large-diameter lens.

PTL 1 discloses an imaging device using a spherical lens. The device of PTL 1 includes the spherical lens and imaging means. The imaging means has a light receiving surface curved along a curved image plane formed by the spherical lens. The spherical lens forms an object image on the light receiving surface of the imaging means.

PTL 2 discloses a light reception device that converts an optical signal into an electric signal. The device of PTL 2 includes a condenser lens such as a spherical lens and a light receiving element having a plurality of light receiving surfaces. Each of the plurality of light receiving surfaces of the light receiving element is configured in such a way that the area increases from a center portion toward a peripheral portion in accordance with the size of a light spot formed by the condenser lens.

### CITATION LIST

### Patent Literature

PTL 1: JP S63-096616 A
PTL 2: JP S63-151232 A

### SUMMARY OF INVENTION

### Technical Problem

In the device of PTL 1, it is possible to implement a high angle of view while suppressing a decrease in peripheral light amount by using the spherical lens. In the device of PTL 1, an imaging element such as a charge coupled device (CCD) having a curved light receiving surface is used. Therefore, it is necessary to adopt a special imaging element having a curved light receiving surface in the device of PTL 1.

In the device of PTL 2, a light receiving system with an improved angle of view can be implemented by combining a wide-angle lens such as a spherical lens and a light receiving element divided on a plane. In the device of PTL 2, the area of the light receiving surface is changed in accordance with an incident angle of the optical signal. Therefore, the device of PTL 2 has a problem that, in a case where spatial optical signals arriving from various directions are received, a difference occurs in received light intensity according to the arrival direction of the spatial optical signal.

An object of the present disclosure is to provide a reception device or the like that can uniformly receive optical signals arriving from various directions with a simple configuration.

### Solution to Problem

A reception device according to an aspect of the present disclosure includes a ball lens that collects an optical signal propagating in a space, a light receiving element array that includes a plurality of light receiving elements that each receive the optical signal collected by the ball lens and outputs a signal derived from the optical signal received by each of the plurality of light receiving elements, and a reception circuit that decodes the signal output from the light receiving element array.

### Advantageous Effects of Invention

According to the present disclosure, it is possible to provide a reception device or the like that can uniformly receive optical signals arriving from various directions with a simple configuration.

### BRIEF DESCRIPTION OF DRAWINGS

FIG. 1 is a conceptual view illustrating an example of a configuration of a reception device according to a first example embodiment.

FIG. 2 is a conceptual view for explaining an example of light collection by a ball lens of the reception device according to the first example embodiment.

FIG. 3 is a conceptual view illustrating an example of a positional relationship between the ball lens and a light receiving element array of the reception device according to the first example embodiment.

FIG. 4 is a conceptual view illustrating a state in which an optical signal collected by the ball lens of the reception device according to the first example embodiment is received by a light receiving element.

FIG. 5 is a conceptual view illustrating an example of reception of a spatial optical signal by the reception device according to the first example embodiment.

FIG. 6 is a conceptual view illustrating another example of the reception of a spatial optical signal by the reception device according to the first example embodiment.

FIG. 7 is a block diagram illustrating an example of a configuration of a reception circuit of the reception device according to the first example embodiment.

FIG. 8 is a conceptual view for explaining a light receiver according to a modified example of the first example embodiment.

FIG. 9 is a conceptual view for explaining a light receiver according to another modified example of the first example embodiment.

FIG. 10 is a conceptual view illustrating an example of a configuration of a reception device according to a second example embodiment.

FIG. 11 is a conceptual view illustrating the example of the configuration of the reception device according to the second example embodiment.

FIG. 12 is a conceptual view for explaining a light receiving range for spatial optical signals that can be received by a ball lens of the reception device according to the second example embodiment.

FIG. 13 is a conceptual view illustrating an example of a positional relationship between the ball lens and a light receiving element array of the reception device according to the second example embodiment.

FIG. 14 is a conceptual view illustrating an example of a configuration of a reception device according to a third example embodiment.

FIG. 15 is a conceptual view illustrating an example of a positional relationship between an optical element and a light receiving element array of the reception device according to the third example embodiment.

FIG. 16 is a conceptual view illustrating a state in which an optical signal guided by the optical element of the reception device according to the third example embodiment is received by a light receiving element.

FIG. 17 is a conceptual view illustrating an example of a positional relationship between an optical element and a light receiving element array of a reception device according to a modified example of the third example embodiment.

FIG. 18 is a conceptual view illustrating an example of a configuration of a reception device according to a fourth example embodiment.

FIG. 19 is a conceptual view illustrating an example of a positional relationship between an optical element and a light receiving element array of the reception device according to the fourth example embodiment.

FIG. 20 is a conceptual view illustrating a state in which an optical signal guided by the optical element of the reception device according to the fourth example embodiment is received by a light receiving element.

FIG. 21 is a conceptual view illustrating an example of a positional relationship between an optical element and a light receiving element array of a reception device according to a modified example of the fourth example embodiment.

FIG. 22 is a conceptual view illustrating an example of a configuration of a reception device according to a fifth example embodiment.

FIG. 23 is a conceptual view illustrating an example of a positional relationship between an optical element and a light receiving element array of the reception device according to the fifth example embodiment.

FIG. 24 is a conceptual view illustrating a state in which an optical signal guided by the optical element of the reception device according to the fifth example embodiment is received by a light receiving element.

FIG. 25 is a conceptual view illustrating an example of a positional relationship between an optical element and a light receiving element array of a reception device according to a modified example of the fifth example embodiment.

FIG. 26 is a conceptual view illustrating an example of a configuration of a reception device according to a sixth example embodiment.

FIG. 27 is a conceptual view illustrating an example of a configuration of a light receiving element array of the reception device according to the sixth example embodiment.

FIG. 28 is a conceptual view illustrating an example of reception of a spatial optical signal by the reception device according to the sixth example embodiment.

FIG. 29 is a conceptual view illustrating another example of the reception of a spatial optical signal by the reception device according to the sixth example embodiment.

FIG. 30 is a block diagram illustrating an example of a configuration of a communication device according to a seventh example embodiment.

FIG. 31 is a conceptual view illustrating an example of a configuration of a transmission device of the communication device according to the seventh example embodiment.

FIG. 32 is a conceptual view illustrating an example of a communication system including the communication device according to the seventh example embodiment.

FIG. 33 is a conceptual view illustrating an example of a configuration of a light receiver included in the communication system including the communication device according to the seventh example embodiment.

FIG. 34 is a conceptual view illustrating another example of the configuration of the light receiver included in the communication system including the communication device according to the seventh example embodiment.

FIG. 35 is a conceptual view illustrating an example of reception of a spatial optical signal by the light receiver included in the communication system including the communication device according to the seventh example embodiment.

FIG. 36 is a conceptual view illustrating another example of the reception of a spatial optical signal by the light receiver included in the communication system including the communication device according to the seventh example embodiment.

FIG. 37 is a conceptual view for explaining Application Example 1 of the seventh example embodiment.

FIG. 38 is a conceptual view for explaining transmission and reception of a spatial optical signal in Application Example 1 of the seventh example embodiment.

FIG. 39 is a conceptual view for explaining Application Example 2 of the seventh example embodiment.

FIG. 40 is a conceptual view illustrating an example of a configuration of a reception device according to an eighth example embodiment.

FIG. 41 is a block diagram illustrating an example of a hardware configuration that implements control and processing according to each example embodiment.

### EXAMPLE EMBODIMENT

Hereinafter, example embodiments of the present invention will be described with reference to the drawings. However, the example embodiments described below have technically preferable limitations for carrying out the present invention, but the scope of the invention is not limited to the following. In all the drawings used in the following description of the example embodiments, the same reference signs are given to the same parts unless there is a particular reason. Further, in the following example embodiments, repeated description of similar configurations and operations may be omitted.

In all the drawings used for description of the following example embodiments, directions of arrows in the drawings are merely examples and do not limit directions of light and signals. In addition, a line indicating a trajectory of light in the drawings is conceptual and does not accurately indicate an actual traveling direction or state of light. For example, in the drawings, a change in traveling direction or state of light due to refraction, reflection, diffusion, or the like at an interface between air and a substance may be omitted, or a light flux may be expressed by one line.

### First Example Embodiment

First, a reception device according to a first example embodiment will be described with reference to the drawings. The reception device of the present example embodiment is used for optical space communication in which an optical signal (hereinafter, also referred to as a spatial optical signal) propagating in a space is transmitted and received without using a medium such as an optical fiber. The reception device of the present example embodiment may be used for applications other than the optical space communication as long as the reception device receives light propagating in a space. In the present example embodiment, unless otherwise specified, the spatial optical signal is regarded as parallel light because the spatial optical signal arrives from a sufficiently distant position.

### Configuration

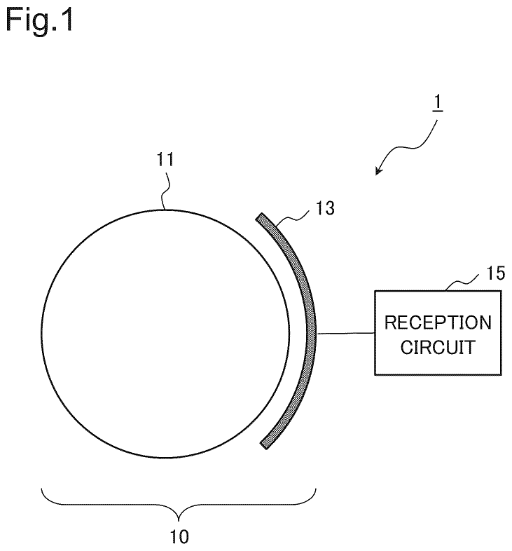

FIG. 1 is a conceptual view illustrating an example of a configuration of a reception device 1 according to the present example embodiment. The reception device 1 includes a ball lens 11, a light receiving element array 13, and a reception circuit 15. The ball lens 11 and the light receiving element array 13 are included in a light receiver 10. FIG. 1 is a plan view of the light receiver 10 as viewed from above. A positional relationship between the ball lens 11 and the light receiving element array 13 is fixed by a support (not illustrated). In the present example embodiment, the support that fixes the ball lens 11 and the light receiving element array 13 is omitted.

The ball lens 11 is a spherical lens. The ball lens 11 is an optical element that collects the spatial optical signal arriving from the outside. The ball lens 11 has a spherical shape when viewed from any angle. The ball lens 11 collects the incident spatial optical signal. Light (also referred to as an optical signal) derived from the spatial optical signal collected by the ball lens 11 is collected toward a light collecting region. The ball lens 11 has a spherical shape and thus collects the spatial optical signal arriving from any direction. That is, the ball lens 11 exhibits similar light collecting performance for the spatial optical signal arriving from any direction.

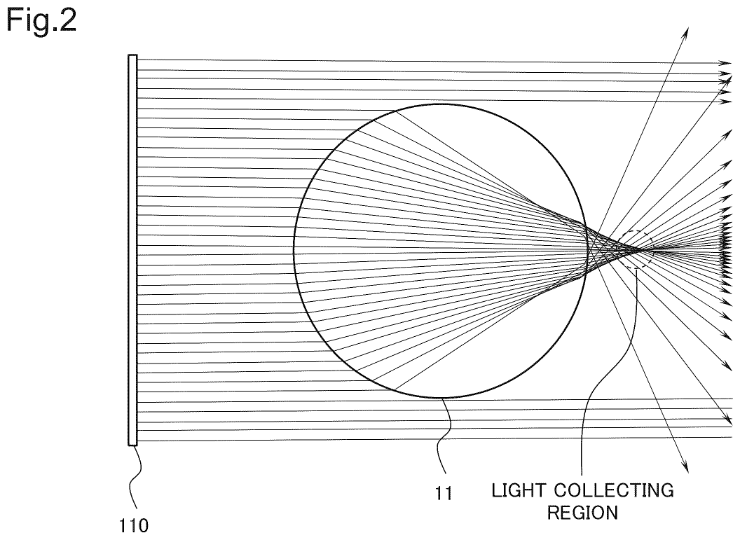

FIG. 2 is a conceptual view illustrating an example of a trajectory of light collected by the ball lens 11. The example in FIG. 2 illustrates a state in which light emitted from a light source 110 that emits parallel light toward the ball lens 11 is refracted by the ball lens 11. The light incident on the ball lens 11 is refracted when entering the inside of the ball lens 11. The light traveling inside the ball lens 11 is refracted again when being emitted to the outside of the ball lens 11. Most of the light refracted by the ball lens 11 is collected in the light collecting region. On the other hand, light incident from the periphery of the ball lens 11 is emitted in a direction deviating from the light collecting region when being emitted from the ball lens 11.

For example, the ball lens 11 can be formed of a material such as glass, crystal, or resin. In a case of receiving the spatial optical signal of a visible range, a material such as glass, crystal, or resin that transmits/refracts light of the visible range can be applied to the ball lens 11. For example, optical glass such as crown glass or flint glass can be applied to the ball lens 11. For example, crown glass such as boron kron (BK) can be applied to the ball lens 11. For example, flint glass such as lanthanum schwerflint (LaSF) can be applied to the ball lens 11. For example, quartz glass can be applied to the ball lens 11. For example, crystal such as sapphire can be applied to the ball lens 11. For example, a transparent resin such as acryl can be applied to the ball lens 11. In a case where the spatial optical signal is light of a near-infrared range (hereinafter, also referred to as a near-infrared ray), a material that transmits a near-infrared ray is used for the ball lens 11. For example, in a case of receiving the spatial optical signal of the near-infrared range of about 1.5 micrometers (μm), a material such as silicon can be applied to the ball lens 11 in addition to glass, crystal, resin, and the like. In a case where the spatial optical signal is light of an infrared range (hereinafter, also referred to as an infrared ray), a material that transmits an infrared ray is used for the ball lens 11. For example, in a case where the spatial optical signal is an infrared ray, a silicon-based material, a germanium-based material, or a chalcogenide-based material can be applied to the ball lens 11. The material of the ball lens 11 is not limited as long as light of a wavelength region of the spatial optical signal can be transmitted/refracted. The material of the ball lens 11 may be appropriately selected according to a required refractive index or use.

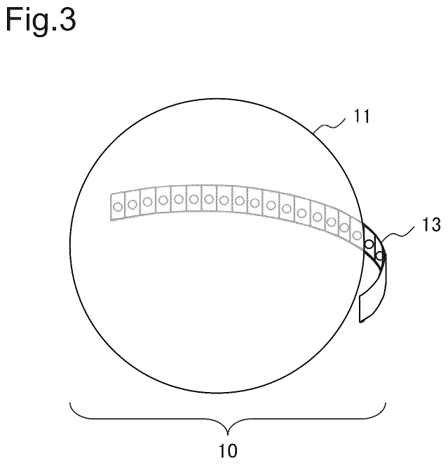

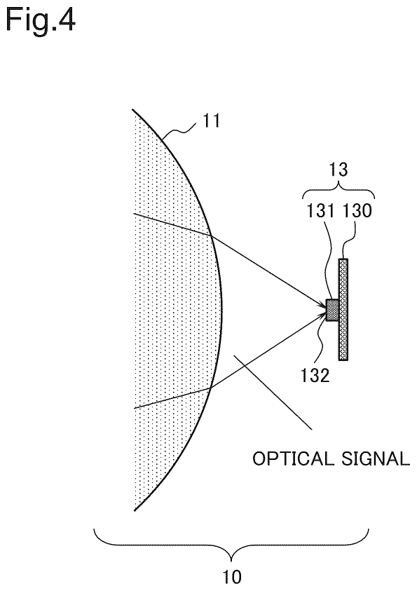

FIG. 3 is a perspective view of the light receiver 10 including the ball lens 11 and the light receiving element array 13. FIG. 3 is a perspective view from above the light receiver 10 viewed from a diagonally elevated perspective on an incident surface side. FIG. 4 is a cross-sectional view of a part of the light receiver 10 including the ball lens 11 and the light receiving element array 13. FIG. 4 illustrates an example in which light receiving elements 131 are arranged on an arc-shaped substrate 130. FIG. 4 illustrates a trajectory of light collected by the ball lens 11. The optical signal collected in the light collecting region where the light receiving element array 13 is arranged by the ball lens 11 is received by any one of the light receiving elements 131 included in the light receiving element array 13. An optical signal deviating from a light receiving portion 132 of the light receiving element 131 is not received by the light receiving element 131.

The light receiving element array 13 includes a plurality of light receiving elements 131 arranged in an arc shape in a circumferential direction of the ball lens 11. The number of light receiving elements 131 included in the light receiving element array 13 is not limited. The light receiving element array 13 is arranged downstream of the ball lens 11. The plurality of light receiving elements 131 each include the light receiving portion 132 that receives an optical signal derived from the spatial optical signal to be received. Each of the plurality of light receiving elements 131 is arranged in such a way that the light receiving portion 132 faces an emission surface of the ball lens 11. Each of the plurality of light receiving elements 131 is arranged in such a way that the light receiving portion 132 is positioned in the light collecting region of the ball lens 11. The optical signal collected by the ball lens 11 is received by the light receiving portion 132 of the light receiving element 131 positioned in the light collecting region. A light receiving surface of each of the plurality of light receiving elements 131 includes a region (also referred to as a non-sensitive region) where the light receiving portion 132 is not positioned.

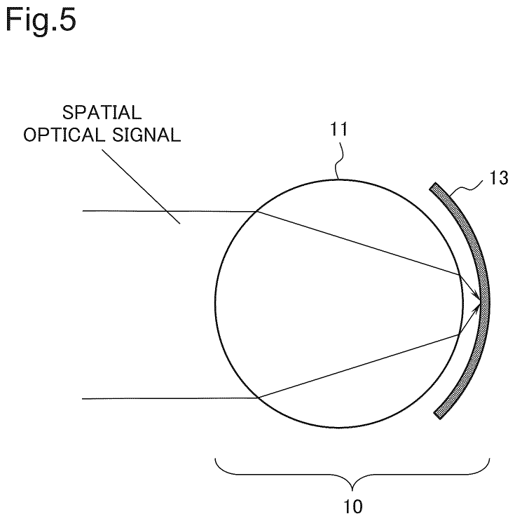

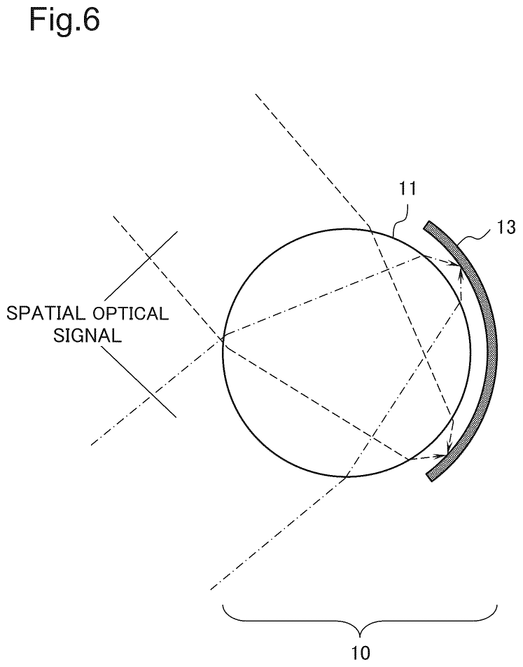

FIG. 5 is a conceptual view illustrating an example in which the reception device 1 receives the spatial optical signal arriving from one direction. FIG. 6 is a conceptual view illustrating an example in which the reception device 1 receives the spatial optical signals arriving from two directions. Since the ball lens 11 is a sphere, the reception device 1 can uniformly receive the spatial optical signal arriving from any direction as long as the spatial optical signal is within a range where light can be received by the light receiving element array 13. For example, in a case where a plane formed by the arc of the light receiving element array 13 is set to be parallel to a horizontal plane, the reception device 1 easily receives the spatial optical signal arriving in the horizontal direction at the same height.

For example, in a case where the plane formed by the arc of the light receiving element array 13 is set to be perpendicular to the horizontal plane, the reception device 1 similarly easily receives the spatial optical signal arriving at an arbitrary height.

The light receiving element 131 receives light of a wavelength region of the spatial optical signal to be received. For example, the light receiving element 131 is sensitive to light of the visible range. For example, the light receiving element 131 is sensitive to light of the infrared range. The light receiving element 131 is sensitive to light having a wavelength in a band of 1.5 μm (micrometer), for example. The wavelength band of light to which the light receiving element 131 is sensitive is not limited to the band of 1.5 μm. Any wavelength band of the light received by the light receiving element 131 can be set in accordance with a wavelength of the spatial optical signal transmitted from a transmission device (not illustrated). The wavelength band of the light received by the light receiving element 131 may be set to, for example, a band of 0.8 μm, a band of 1.55 μm, or a band of 2.2 μm. Further, the wavelength band of the light received by the light receiving element 131 may be, for example, a band of 0.8 to 1 μm. A shorter wavelength band is advantageous for optical space communication during rainfall because absorption by moisture in the atmosphere is small. In a case where the light receiving element 131 is saturated with intense sunlight, the light receiving element cannot read the optical signal derived from the spatial optical signal. Therefore, a color filter that selectively passes light of the wavelength band of the spatial optical signal may be installed upstream of the light receiving element 131.

For example, the light receiving element 131 can be implemented by an element such as a photodiode or a phototransistor. For example, the light receiving element 131 is implemented by an avalanche photodiode. The light receiving element 131 implemented by the avalanche photodiode can support high-speed communication. The light receiving element 131 may be implemented by an element other than a photodiode, a phototransistor, or an avalanche photodiode as long as an optical signal can be converted into an electric signal. In order to increase the communication speed, the light receiving portion 132 of the light receiving element 131 may be as small as possible. For example, the light receiving portion 132 of the light receiving element 131 has a square light receiving surface of which a side has a size of about 5 mm (mm). For example, the light receiving portion 132 of the light receiving element 131 has a circular light receiving surface having a diameter of about 0.1 to 0.3 mm. It is sufficient if the size and shape of the light receiving portion 132 of the light receiving element 131 are selected according to the wavelength band of the spatial optical signal, the communication speed, and the like.

The light receiving element 131 converts the received optical signal into an electric signal. The light receiving element 131 outputs the converted electric signal to the reception circuit 15. Although only one line (path) is illustrated between the light receiving element array 13 and the reception circuit 15 in FIG. 1, the light receiving element array 13 and the reception circuit 15 may be connected by a plurality of paths. For example, each of the light receiving elements 131 included in the light receiving element array 13 may be individually connected to the reception circuit 15. For example, each group of the light receiving elements 131 included in the light receiving element array 13 may be connected to the reception circuit 15.

The reception circuit 15 acquires a signal output from each of the plurality of light receiving elements 131. The reception circuit 15 amplifies the signal from each of the plurality of light receiving elements 131. The reception circuit 15 decodes the amplified signal and analyzes the signal from a communication target. For example, the reception circuit 15 is configured to collectively analyze the signals of the plurality of light receiving elements 131. In a case where the signals of the plurality of light receiving elements 131 are collectively analyzed, it is possible to implement the single-channel reception device 1 that communicates with a single communication target. For example, the reception circuit 15 is configured to individually analyze the signal for each of the plurality of light receiving elements 131. In a case where the signal is individually analyzed for each of the plurality of light receiving elements 131, it is possible to implement the multi-channel reception device 1 that communicates with a plurality of communication targets simultaneously. The signal decoded by the reception circuit 15 is used for any purpose. The use of the signal decoded by the reception circuit 15 is not particularly limited.

### [Reception Circuit]

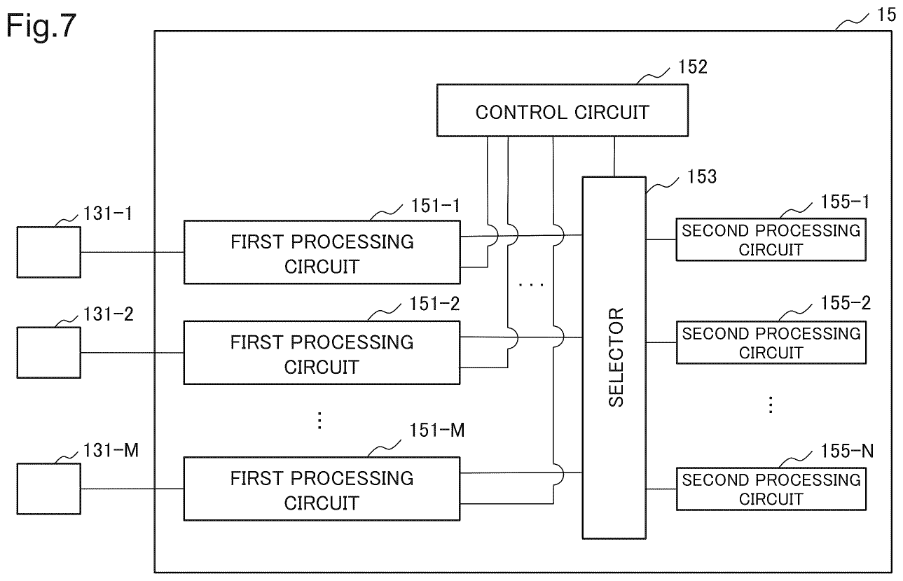

Next, an example of a detailed configuration of the reception circuit 15 included in the reception device 1 will be described with reference to the drawings. FIG. 7 is a block diagram illustrating an example of the configuration of the reception circuit 15. In the example of FIG. 7, the number of light receiving elements 131 included in the light receiving element array 13 is M (M is a natural number). FIG. 7 illustrates an example of the configuration of the reception circuit 15, and does not limit the configuration of the reception circuit 15.

The reception circuit 15 includes a plurality of first processing circuits 151-1 to 151-M, a control circuit 152, a selector 153, and a plurality of second processing circuits 155-1 to 155-N (M and N are natural numbers). The first processing circuit 151 is associated with any one of the plurality of light receiving elements 131-1 to 131-M. The first processing circuit 151 may be configured for each group of the plurality of light receiving elements 131 included in the plurality of light receiving elements 131-1 to 131-M.

For example, the first processing circuit 151 includes a high-pass filter (not illustrated). The high-pass filter acquires a signal from the light receiving element 131. The high-pass filter selectively passes a signal of a high-frequency component associated to a wavelength band of the spatial optical signal in the acquired signal. The high-pass filter cuts a signal derived from ambient light such as sunlight. For example, a band pass filter that selectively passes a signal in a wavelength band of the spatial optical signal may be configured instead of the high-pass filter. When the light receiving element 131 is saturated with intense sunlight, the optical signal cannot be read. Therefore, a color filter that selectively passes light of the wavelength band of the spatial optical signal may be installed upstream of the light receiving portion of the light receiving element 131.

For example, the first processing circuit 151 includes an amplifier (not illustrated). The amplifier acquires a signal output from the high-pass filter. The amplifier amplifies the acquired signal. An amplification factor for the signal in the amplifier is not particularly limited.

For example, the first processing circuit 151 includes an output monitor (not illustrated). The output monitor monitors an output value of the amplifier. The output monitor outputs a signal exceeding a predetermined output value among the signals amplified by the amplifier to the selector 153. Among the signals output to the selector 153, a signal to be received is allocated to any one of the plurality of second processing circuits 155-1 to 155-N under the control of the control circuit 152. The signal to be received is the spatial optical signal from a communication device (not illustrated) as a communication target. A signal from the light receiving element 131 that is not used for receiving the spatial optical signal is not output to the second processing circuit 155.

For example, the first processing circuit 151 may include an integrator (not illustrated) as the output monitor (not illustrated). The integrator acquires a signal output from the high-pass filter. The integrator integrates the acquired signal. The integrator outputs the integrated signal to the control circuit 152. The integrator is arranged to measure an intensity of the spatial optical signal received by the light receiving element 131. Since the spatial optical signal received in a state where a beam diameter is not narrowed has a lower intensity than that in a case where the beam diameter is narrowed, it is difficult to measure a voltage of the signal amplified only by the amplifier. In a case of using the integrator, for example, the voltage of the signal can be increased to a level at which the voltage can be measured by integrating a signal in a period of several milliseconds to several tens of milliseconds.

The control circuit 152 acquires a signal output from each of the plurality of first processing circuits 151-1 to 151-M. In other words, the control circuit 152 acquires a signal derived from an optical signal received by each of the plurality of light receiving elements 131-1 to 131-M. For example, the control circuit 152 compares read values of the signals from the plurality of light receiving elements 131 adjacent to each other. The control circuit 152 selects the light receiving element 131 having the highest signal intensity according to the comparison result. The control circuit 152 controls the selector 153 in such a way as to allocate the signal derived from the selected light receiving element 131 to any one of the plurality of second processing circuits 155-1 to 155-N.

In a case where the position of the communication target is specified in advance, it is sufficient if the signals output from the light receiving elements 131-1 to 131-M are output to any one preset second processing circuit 155 without executing processing of estimating the arrival direction of the spatial optical signal. On the other hand, in a case where the position of the communication target is not specified in advance, it is sufficient if the second processing circuit 155 as an output destination of the signals output from the light receiving elements 131-1 to 131-M is selected. For example, as the control circuit 152 selects the light receiving element 131, the arrival direction of the spatial optical signal can be estimated. That is, selection of the light receiving element 131 by the control circuit 152 corresponds to specification of the communication device as a transmission source of the spatial optical signal. Further, F allocation of the signal from the light receiving element 131 selected by the control circuit 152 to any one of the plurality of second processing circuits corresponds to association of the specified communication target with the light receiving element 131 that receives the spatial optical signal from the communication target. That is, the control circuit 152 can specify the communication device as the transmission source of the optical signal (spatial optical signal) based on the optical signal received by each of the plurality of light receiving elements 131-1 to 131-M.

The signal amplified by the amplifier included in each of the plurality of first processing circuits 151-1 to 151-M is input to the selector 153. The selector 153 outputs a signal to be received among the input signals to any one of the plurality of second processing circuits 155-1 to 155-N under the control of the control circuit 152. A signal not intended for reception is not output from the selector 153.

The signal from any one of the plurality of light receiving elements 131-1 to 131-N allocated by the control circuit 152 is input to the plurality of second processing circuits 155-1 to 155-N. Each of the plurality of second processing circuits 155-1 to 155-N decodes the input signal. Each of the plurality of second processing circuits 155-1 to 155-N may be configured to execute some signal processing on the decoded signal, or may be configured to output the signal to an external signal processing device or the like (not illustrated).

The selector 153 selects a signal derived from the light receiving element 131 selected by the control circuit 152, whereby one second processing circuit 155 is allocated to one communication target. That is, the control circuit 152 allocates the signal derived from the spatial optical signal received from each of the plurality of communication targets by each of the plurality of light receiving elements 131-1 to 131-M to any one of the plurality of second processing circuits 155-1 to 155-N. As a result, the reception device 1 can simultaneously read the signals derived from the spatial optical signals from the plurality of communication targets on individual channels. For example, in order to simultaneously communicate with a plurality of communication targets, the spatial optical signals from the plurality of communication targets may be read in a time division manner on a single channel. In the method of the present example embodiment, the spatial optical signals from a plurality of communication targets are simultaneously read on a plurality of channels, and thus, a transmission speed is faster than that in a case where a single channel is used.

For example, the arrival direction of the spatial optical signal may be specified by primary scanning with low accuracy, and secondary scanning with high accuracy may be performed on the specified direction to specify the accurate position of the communication target. When communication with the communication target becomes possible, the accurate position of the communication target can be determined by exchanging a signal with the communication target. In a case where the position of the communication target is specified in advance, the processing of specifying the position of the communication target can be omitted.

### Modified Example 1

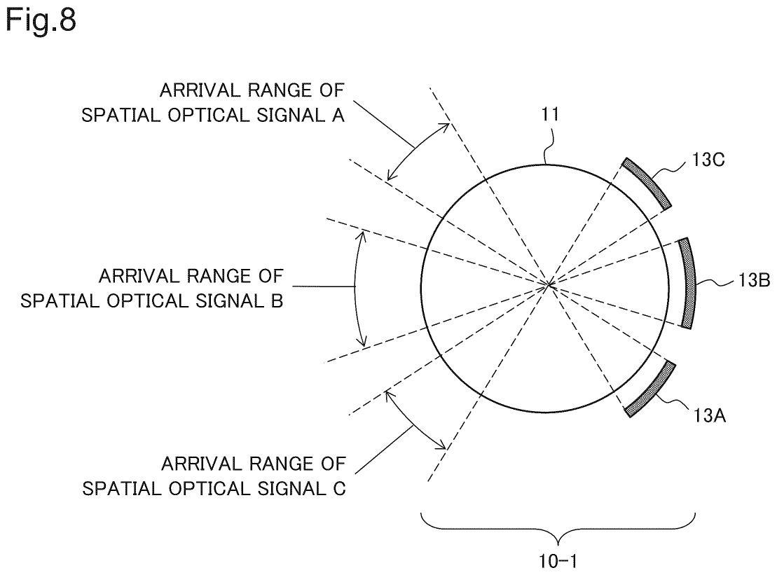

Next, a modified example (Modified Example 1) according to the present example embodiment will be described with reference to the drawings. FIG. 8 is a conceptual view illustrating an example of a configuration of a light receiver 10-1 of the present modified example. FIG. 8 is a plan view of the light receiver 10-1 as viewed from above. The light receiver 10-1 of the present modified example includes a ball lens 11 and a plurality of light receiving element arrays 13 (13A, 13B, and 13C). FIG. 8 illustrates an example in which the number of light receiving element arrays 13 is three, but the number of light receiving element arrays 13 is not particularly limited.

The light receiver 10-1 of the present modified example is suitable for a case where the arrival direction of the spatial optical signal is limited. In a case where the arrival direction of the spatial optical signal is limited, there is a region in which the spatial optical signal is not received. In the present modified example, the light receiving element arrays 13 are arranged in accordance with arrival ranges of the spatial optical signals. A plurality of light receiving elements 131 may be arranged on the same substrate in accordance with the arrival ranges of the spatial optical signals without using the plurality of light receiving element arrays 13.

The light receiving element array 13A is arranged in association with an arrival range of a spatial optical signal A. The light receiving element array 13A receives the spatial optical signal arriving from the arrival range of the spatial optical signal A. The light receiving element array 13B is arranged in association with an arrival range of a spatial optical signal B. The light receiving element array 13B receives the spatial optical signal arriving from the arrival range of the spatial optical signal B. The light receiving element array 13C is arranged in association with an arrival range of a spatial optical signal C. The light receiving element array 13C receives the spatial optical signal arriving from the arrival range of the spatial optical signal C.

In a case where a direction of the communication target is specified, a circuit scale can be reduced by omitting the light receiving element 131 in a portion where the spatial optical signal does not arrive. In a case where the number of light receiving elements 131 is reduced, the cost of the device can be reduced. That is, according to the present modified example, reduction in circuit scale and cost reduction are achieved.

### Modified Example 2

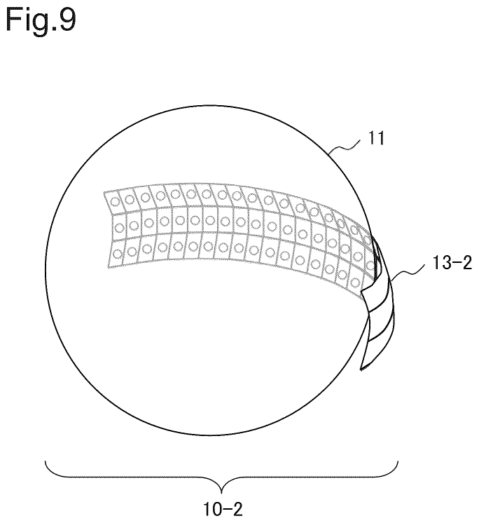

Next, another modified example (modified example 2) according to the present example embodiment will be described with reference to the drawings. FIG. 9 is a conceptual view illustrating an example of a configuration of a light receiver 10-2 of the present modified example. FIG. 9 is a perspective view of the light receiver 10-2 viewed from a diagonally elevated perspective on an incident surface side. The light receiver 10-2 of the present modified example includes a ball lens 11 and a light receiving element array 13-2. The light receiving element array 13-2 has a structure in which a plurality of light receiving element arrays 13 overlap each other in a short side direction. Each of the plurality of light receiving element arrays 13 is arranged in a light collecting region of the ball lens 11. That is, the light receiving element array 13-2 includes light receiving elements 131 arranged in a two-dimensional array on a curved surface of the light receiving element array 13-2 formed in accordance with the light collecting region of the ball lens 11. FIG. 9 illustrates an example in which the light receiving element array 13-2 includes three light receiving element arrays 13 overlapping each other, but the number of light receiving element arrays 13 included in the light receiving element array 13-2 is not particularly limited.

The light receiver 10-2 of the present modified example can similarly receive the spatial optical signal arriving at the ball lens 11 even when the arrival direction of the spatial optical signal is slightly shifted in the short side direction of the light receiving element array 13-2. In other words, according to the present modified example, even when the arrival direction of the spatial optical signal vertically fluctuates with respect to a plane including an arc of the light receiving element array 13-2, signal light derived from the spatial optical signal can be received by the plurality of light receiving element arrays 13 included in the light receiving element array 13-2.

In a case where the arrival direction of the spatial optical signal is not limited to the same plane, when the spatial optical signal three-dimensionally arriving at the ball lens 11 cannot be received, there is a possibility that communication with a desired communication target cannot be performed. In the present modified example, the light receiving element array 13-2 in which the plurality of light receiving elements 131 are arranged in a two-dimensional array is used, so that a light receiving range for the spatial optical signal can be expanded as compared with the light receiving element array 13.

As described above, the reception device of the present example embodiment includes the ball lens, the light receiving element array, and the reception circuit. The ball lens collects an optical signal propagating in a space. The light receiving element array includes the plurality of light receiving elements arranged in an arc shape in the circumferential direction of the ball lens in the light collecting region of the ball lens. The light receiving element array outputs signals derived from the optical signals received by the plurality of light receiving elements. The reception circuit decodes the signals output from the light receiving element array.

In the reception device according to the present example embodiment, a plurality of receiving elements arranged in an arc shape in the light collecting region of the ball lens receive optical signals collected by the ball lens. The ball lens collects an optical signal arriving from any direction in the surrounding light collecting region. Therefore, according to the present example embodiment, optical signals arriving from various directions can be uniformly received with a simple configuration.

A reception device according to an aspect of the present example embodiment includes at least one light receiving element array arranged in accordance with an arrival direction of a spatial optical signal. In this aspect, the light receiving element array is arranged at a position where an optical signal is collected, and the light receiving element array is not arranged at a position where the optical signal is not collected. Therefore, according to this aspect, unnecessary light receiving elements can be omitted.

In an aspect of the present example embodiment, a light receiving element array includes a plurality of light receiving elements arranged in a two-dimensional array in a circumferential direction of a ball lens in a light collecting region of the ball lens. According to this aspect, a light receiving angle of a spatial optical signal can be expanded with respect to a direction perpendicular to an arrangement direction of the plurality of light receiving elements.

### Second Example Embodiment

Next, a reception device according to a second example embodiment will be described with reference to the drawings. The reception device of the present example embodiment is different from the reception device of the first example embodiment in that a reception element array formed in an annular shape is arranged in such a way as to surround a ball lens.

### Configuration

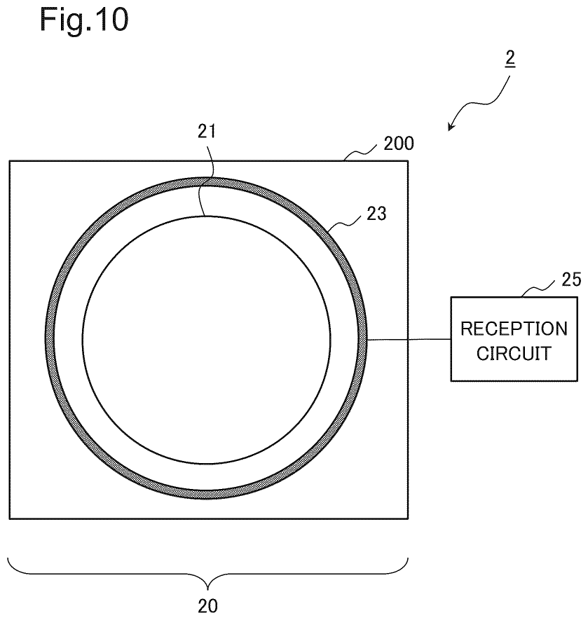

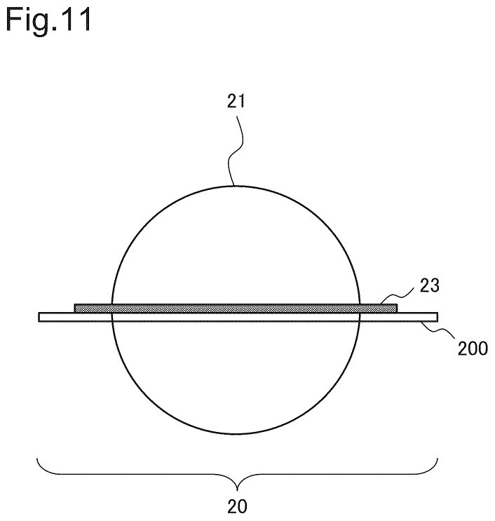

FIG. 10 is a conceptual view illustrating an example of a configuration of a reception device 2 according to the present example embodiment. The reception device 2 includes a ball lens 21, a light receiving element array 23, and a reception circuit 25. The ball lens 21 and the light receiving element array 23 are included in a light receiver 20. FIG. 10 is a plan view of the light receiver 20 as viewed from above. FIG. 11 is a side view of the reception device 2 as viewed from a direction perpendicular to a plane including a circle formed by the light receiving element array 23. The light receiving element array 23 is arranged on a substrate 200 having a cut-out portion where the ball lens 21 is arranged. The substrate 200 may be included in the light receiver 20. A positional relationship between the ball lens 21 and the light receiving element array 23 is fixed by a support (not illustrated). In the present example embodiment, the support that fixes the ball lens 21 and the light receiving element array 23 is omitted. The ball lens 21 and the light receiving element array 23 may be fixed by the substrate 200.

The ball lens 21 has the same configuration as the ball lens 11 of the first example embodiment. The ball lens 21 collects a spatial optical signal arriving from the outside in a light collecting region of the ball lens 21.

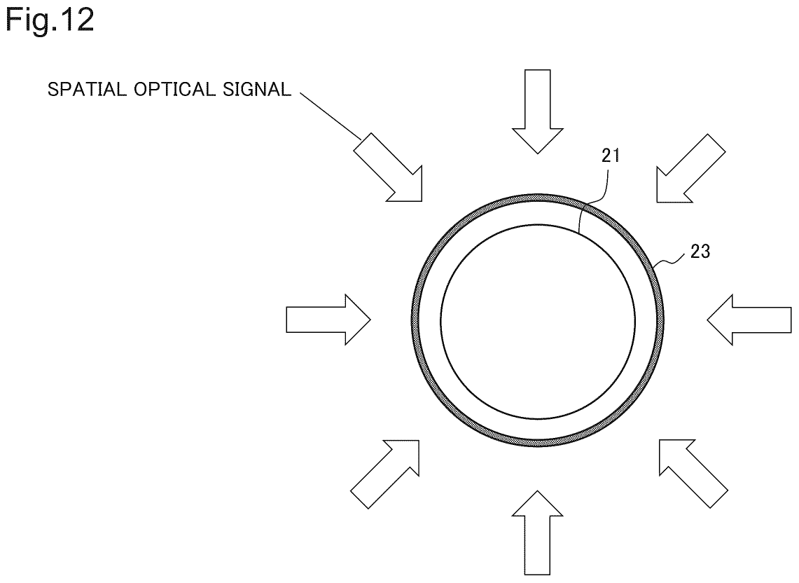

FIG. 12 is a conceptual view for explaining a light receiving range for the spatial optical signal that can be received by the ball lens 21. FIG. 12 is a plan view of the light receiver 20 as viewed from above. The spatial optical signal arriving toward the ball lens 21 is partially blocked by the light receiving element array 23 and the substrate 200, but most of the spatial optical signal is collected by the ball lens 21 and received by the light receiving element array 23. As illustrated in FIG. 12, the reception device 2 of the present example embodiment can receive the spatial optical signal arriving from any direction of 360 degrees in a plane parallel to the plane including the circle formed by the light receiving element array 23.

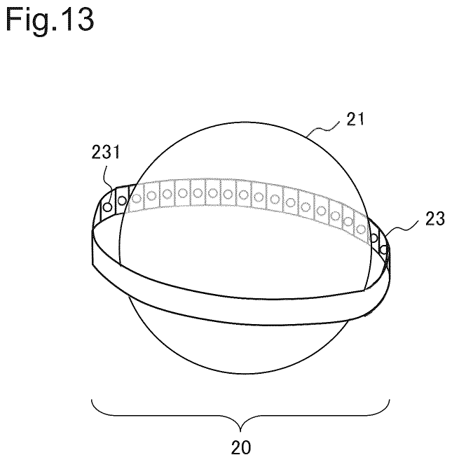

FIG. 13 is a perspective view of the light receiver 20 including the ball lens 21 and the light receiving element array 23. FIG. 13 is a perspective view of the light receiver 20 viewed from a diagonally elevated perspective on an incident surface side. The light receiving element array 23 includes a plurality of light receiving elements 231 arranged in an annular shape in a circumferential direction of the ball lens 21. Each of the plurality of light receiving elements 231 included in the light receiving element array 23 has the same configuration as the light receiving element 131 of the first example embodiment. The number of light receiving elements 231 included in the light receiving element array 23 is not limited. The light receiving element array 23 is arranged downstream of the ball lens 21. The plurality of light receiving elements 231 include a light receiving portion (not illustrated) that receives an optical signal derived from the spatial optical signal to be received. Each of the plurality of light receiving elements 231 is arranged in such a way that a light receiving portion faces an emission surface of the ball lens 21. Each of the plurality of light receiving elements 231 is arranged in such a way that the light receiving portion is positioned in the light collecting region of the ball lens 21. The optical signal collected by the ball lens 21 is received by the light receiving portion of the light receiving element 231 positioned in the light collecting region.

Each of the plurality of light receiving elements 231 included in the light receiving element array 23 converts the received optical signal into an electric signal. Each of the plurality of light receiving elements 231 included in the light receiving element array 23 outputs the converted electric signal to the reception circuit 25. Although only one line (path) is illustrated between the light receiving element array 23 and the reception circuit 25 in FIG. 10, the light receiving element array 23 and the reception circuit 25 may be connected by a plurality of paths. For example, each of the light receiving elements 231 included in the light receiving element array 23 may be individually connected to the reception circuit 25. For example, each group of the light receiving elements 231 included in the light receiving element array 23 may be connected to the reception circuit 25.

The reception circuit 25 has the same configuration as the reception circuit 15 of the first example embodiment. The reception circuit 25 acquires a signal output from each of the plurality of light receiving elements 231 included in the light receiving element array 23. The reception circuit 25 amplifies the signal from each of the plurality of light receiving elements 231. The reception circuit 25 decodes the amplified signal and analyzes the signal from a communication target. The signal decoded by the reception circuit 25 is used for any purpose. The use of the signal decoded by the reception circuit 25 is not particularly limited.

As described above, the reception device of the present example embodiment includes the ball lens, the light receiving element array, and the reception circuit. The ball lens collects an optical signal propagating in a space. The light receiving element array includes the plurality of light receiving elements. The plurality of light receiving elements are arranged in an annular shape in the light collecting region of the ball lens in such a way as to surround the ball lens. The light receiving element array outputs signals derived from the optical signals received by the plurality of light receiving elements. The reception circuit decodes the signals output from the light receiving element array.

In the reception device according to the present example embodiment, a plurality of receiving elements arranged in an annular shape in the light collecting region of the ball lens receive optical signals collected by the ball lens. The ball lens collects an optical signal arriving from any direction substantially parallel to a plane including a ring formed by the plurality of light receiving elements in the light collecting region. Since the plurality of receiving elements are arranged in an annular shape in the light collecting region of the ball lens, it is possible to receive a spatial optical signal arriving from any direction along a surface of the ring formed by the light receiving element array. That is, according to the present example embodiment, the spatial optical signal arriving from any direction of 360 degrees can be received.

### Third Example Embodiment

Next, a reception device according to a third example embodiment will be described with reference to the drawings. The reception device of the present example embodiment is different from the reception device of the first example embodiment in including a cylindrical lens that refracts signal light collected by a ball lens in a direction substantially perpendicular to a direction in which the signal light is refracted. The reception device of the present example embodiment may be combined with the configuration of the second example embodiment.

### Configuration

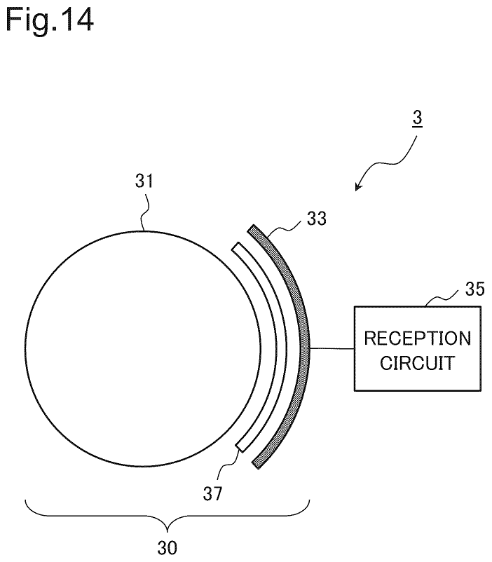

FIG. 14 is a conceptual view illustrating an example of a configuration of a reception device 3 according to the present example embodiment. The reception device 3 includes a ball lens 31, a light receiving element array 33, a reception circuit 35, and an optical element 37. The ball lens 31, the light receiving element array 33, and the optical element 37 are included in a light receiver 30. FIG. 14 is a plan view of the light receiver 30 as viewed from above.

The ball lens 31 has the same configuration as the ball lens 11 of the first example embodiment. The ball lens 31 collects a spatial optical signal arriving from the outside in a light collecting region of the ball lens 31.

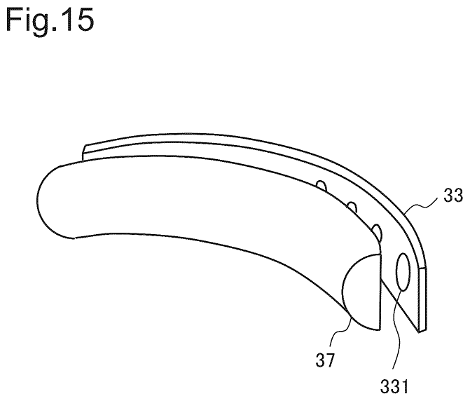

FIG. 15 is a perspective view illustrating an example of a positional relationship between the light receiving element array 33 and the optical element 37. FIG. 15 is a perspective view of the optical element 37 viewed from a diagonally elevated perspective on an incident surface side. The light receiving element array 33 and the optical element 37 have a shape bent in an arc shape toward the center of the ball lens 31.

The optical element 37 is a cylindrical lens bent in an arc shape. The optical element 37 has a shape bent in an arc shape with a curved surface (first surface) of the cylindrical lens facing inward and a flat surface (second surface) facing outward. The optical element 37 is formed with a curvature based on the light collecting region formed around the ball lens 31. The optical element 37 is arranged between the ball lens 31 and the light receiving element array 33. The first surface of the optical element 37 faces an emission surface of the ball lens 31. The second surface of the optical element 37 faces a light receiving surface of the light receiving element array 33. The optical element 37 collects an optical signal collected by the ball lens 31 toward a light receiving element 331 included in the light receiving element array 33.

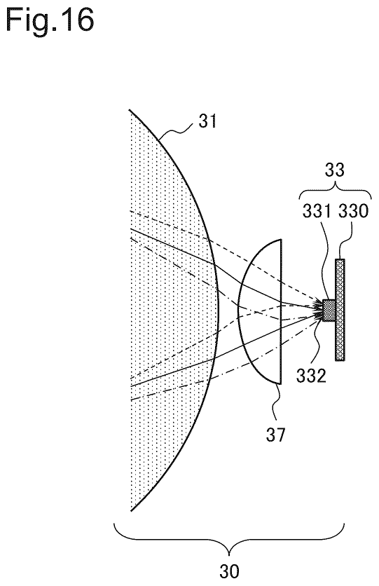

FIG. 16 is a cross-sectional view of a part of the light receiver 30 including the ball lens 31, the light receiving element array 33, and the optical element 37. FIG. 16 illustrates an example in which the light receiving elements 331 are arranged on an arc-shaped substrate 330. FIG. 16 illustrates a trajectory of light collected by the ball lens 31. The optical signal collected in the light collecting region of the ball lens 31 by the ball lens 31 is collected by the optical element 37. The optical signal collected by the optical element 37 is received by any one of the light receiving elements 331 included in the light receiving element array 33 arranged in the light collecting region of the optical element 37.

The light receiving element array 33 has the same configuration as the light receiving element array 13 of the first example embodiment. The light receiving element array 33 is arranged downstream of the optical element 37. The plurality of light receiving elements 331 included in the light receiving element array 33 each include a light receiving portion 332 that receives an optical signal derived from the spatial optical signal to be received. Each of the plurality of light receiving elements 331 is arranged in such a way that the light receiving portion 332 faces the emission surface of the optical element 37. Each of the plurality of light receiving elements 331 is arranged in such a way that the light receiving portion 332 is positioned in the light collecting region of the optical element 37. The optical signal collected by the ball lens 31 is collected by the optical element 37 and received by the light receiving portion 332 of the light receiving element 331.

In the configuration of the first example embodiment, in a case where the spatial optical signal spreading in a direction parallel to a horizontal plane is received, an arc formed by the light receiving element array 13 is arranged to be substantially parallel to the horizontal plane. With such an arrangement, it is possible to cause each of the plurality of light receiving elements 131 to share the reception of the spatial optical signals arriving from various directions. However, in such an arrangement, since the spatial optical signal spreading in a direction perpendicular to the horizontal plane is incident while being shifted in the short side direction of the light receiving element array 13, it is difficult to efficiently receive the light. On the other hand, in the configuration of the present example embodiment, the optical signal incident while being shifted in a short side direction of the light receiving element array 33 is collected in the short side direction by the optical element 37. Therefore, with the configuration of the present example embodiment, the spatial optical signal spreading in the direction perpendicular to the horizontal plane is easily received as compared with the configuration of the first example embodiment.

Each of the plurality of light receiving elements 331 included in the light receiving element array 33 converts the received optical signal into an electric signal. Each of the plurality of light receiving elements 331 included in the light receiving element array 33 outputs the converted electric signal to the reception circuit 35. Although only one line (path) is illustrated between the light receiving element array 33 and the reception circuit 35 in FIG. 14, the light receiving element array 33 and the reception circuit 35 may be connected by a plurality of paths. For example, each of the plurality of light receiving elements 331 included in the light receiving element array 33 may be individually connected to the reception circuit 35. For example, each group of the plurality of light receiving elements 331 included in the light receiving element array 33 may be connected to the reception circuit 35.

The reception circuit 35 has the same configuration as the reception circuit 15 of the first example embodiment. The reception circuit 35 acquires a signal output from each of the plurality of light receiving elements 331 included in the light receiving element array 33. The reception circuit 35 amplifies the signal from each of the plurality of light receiving elements 331. The reception circuit 35 decodes the amplified signal and analyzes the signal from a communication target. The signal decoded by the reception circuit 35 is used for any purpose. The use of the signal decoded by the reception circuit 35 is not particularly limited.

### Modified Example 3

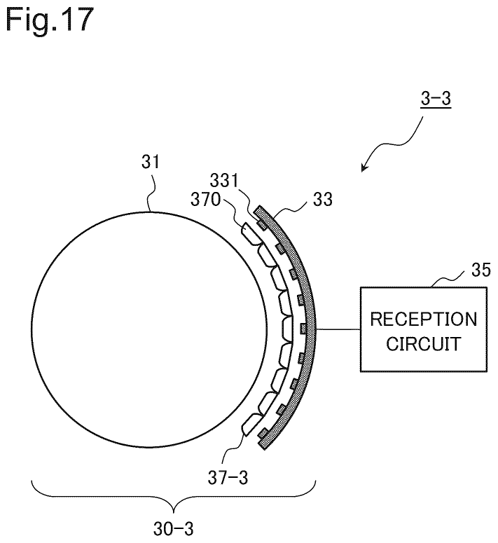

Next, a modified example (Modified Example 3) of the present example embodiment will be described with reference to the drawings. FIG. 17 is a conceptual view illustrating an example of a configuration of a reception device 3-3 according to the present modified example. The reception device 3-3 includes a ball lens 31, a light receiving element array 33, a reception circuit 35, and an optical element 37-3. The ball lens 31, the light receiving element array 33, and the optical element 37-3 are included in a light receiver 30-3. FIG. 17 is a plan view of the light receiver 30-3 as viewed from above. The reception device of the present modified example includes the optical element 37-3 in which a plurality of cylindrical lenses are combined. FIG. 17 is a perspective view illustrating an example of a positional relationship between the light receiving element array 33 and the optical element 37-3. FIG. 17 is a perspective view of the optical element 37-3 viewed from a diagonally elevated perspective on an incident surface side. The light receiving element array 33 and the optical element 37-3 have a shape bent in an arc shape toward the center of the ball lens 31.

The optical element 37-3 has a structure in which a plurality of partial optical elements 370 are combined. Each of the plurality of partial optical elements 370 is associated with each of a plurality of light receiving elements 331. For example, the partial optical element 370 is a cylindrical lens. The partial optical elements 370 are arranged in an arc shape with a curved surface (first surface) of the cylindrical lens facing the ball lens 31 and a flat surface (second surface) facing the light receiving element 331. The partial optical element 370 is arranged with a curvature based on a light collecting region formed around the ball lens 31. The partial optical element 370 is arranged between the ball lens 31 and the light receiving element array 33. The first surface of the partial optical element 370 faces an emission surface of the ball lens 31. The second surface of the partial optical element 370 faces a light receiving surface of the light receiving element 331. The partial optical element 370 collects an optical signal collected by the ball lens 31 toward the associated light receiving element 331. The partial optical element 370 collects the optical signal in a short side direction of the light receiving element array 33 and collects the optical signal in a long side direction of the light receiving element array 33. That is, the partial optical element 370 collects the optical signal collected by the ball lens 31 toward the associated light receiving element 331.

The optical signal collected in the light collecting region where the optical element 37-3 is arranged by the ball lens 31 is collected by any one of the partial optical elements 370 included in the optical element 37-3. The optical signal collected by the partial optical element 370 is received by the light receiving element 331 arranged in the light collecting region of the partial optical element 370.

As the optical element 37-3 of the present modified example is used, the optical signal can be guided toward the light receiving element 331 also in the long side direction, similarly to the guidance in the short side direction of the light receiving element array 33. In a case of using the optical element 37, it is not possible to receive light collected in a non-sensitive region deviating from the light receiving element array 33 while performing light collection on the light receiving element 331. The light collected in the non-sensitive region deviating from the light receiving element 331 can be guided to the light receiving element 331 by using the optical element 37-3 of the present modified example. That is, as the optical element 37-3 of the present modified example is used, light receiving efficiency for the optical signal can be improved as compared with a case of using the optical element 37.

As described above, the reception device of the present example embodiment includes the ball lens, the light receiving element array, the optical element, and the reception circuit. The ball lens collects an optical signal propagating in a space. The light receiving element array includes the plurality of light receiving elements that receive optical signals collected by the ball lens. The optical element is arranged between the ball lens and the light receiving element array. The optical element guides the optical signal collected by the ball lens toward the light receiving portion of any one of the light receiving elements included in the light receiving element array. For example, the optical element is a cylindrical lens bent in an arc shape with the flat surface facing outward in the circumferential direction of the ball lens. The optical element collects the optical signal collected by the ball lens in a direction orthogonal to an arrangement direction of the light receiving element array, and guides the optical signal to the light receiving portion of any one of the light receiving elements included in the light receiving element array. The light receiving element array outputs signals derived from the optical signals received by the plurality of light receiving elements. The reception circuit decodes the signals output from the light receiving element array.

In the reception device according to the present example embodiment, the cylindrical lens bent in an arc shape with the flat surface facing outward in the circumferential direction of the ball lens collects an optical signal in a direction perpendicular to the arrangement direction of the plurality of light receiving elements. According to the present example embodiment, the optical element guides the optical signal deviating in a direction perpendicular to the arrangement direction of the plurality of light receiving elements toward the light receiving portion of the light receiving element, so that the light receiving efficiency for the optical signal can be improved.

### Fourth Example Embodiment

Next, a reception device according to a fourth example embodiment will be described with reference to the drawings. The reception device of the present example embodiment is different from the reception device of the first example embodiment in including a diffractive optical element (DOE) that refracts signal light collected by a ball lens in a direction substantially perpendicular to a direction in which the signal light is refracted. The reception device of the present example embodiment may be combined with the configuration of the second example embodiment.

### Configuration

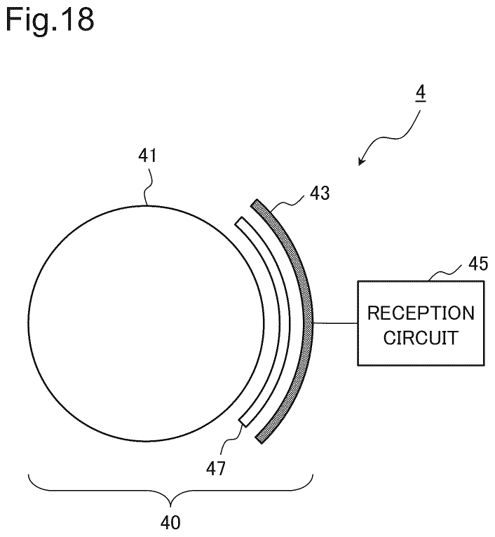

FIG. 18 is a conceptual view illustrating an example of a configuration of a reception device 4 according to the present example embodiment. The reception device 4 includes a ball lens 41, a light receiving element array 43, a reception circuit 45, and an optical element 47. The ball lens 41, the light receiving element array 43, and the optical element 47 are included in a light receiver 40. FIG. 18 is a plan view of the light receiver 40 as viewed from above.

The ball lens 41 has the same configuration as the ball lens 11 of the first example embodiment. The ball lens 41 collects a spatial optical signal arriving from the outside in a light collecting region of the ball lens 41.

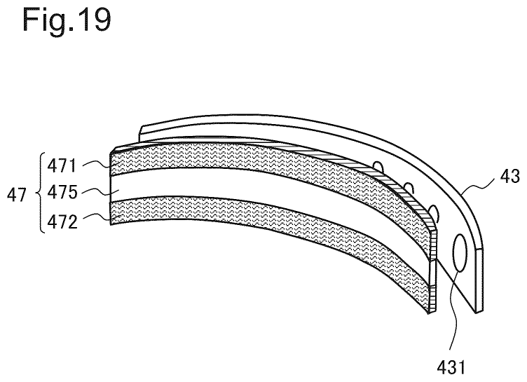

FIG. 19 is a perspective view illustrating an example of a positional relationship between the light receiving element array 43 and the optical element 47. FIG. 19 is a perspective view of the optical element 47 viewed from a diagonally elevated perspective on an incident surface side. The light receiving element array 43 and the optical element 47 have a shape bent in an arc shape toward the center of the ball lens 41.

The optical element 47 (also referred to as a diffractive optical element) includes a first diffraction portion 471, a second diffraction portion 472, and a transparent portion 475. The first diffraction portion 471, the second diffraction portion 472, and the transparent portion 475 have a shape bent in an arc shape toward the center of the ball lens 41. The first diffraction portion 471 and the second diffraction portion 472 sandwich the transparent portion 475 therebetween. For example, the first diffraction portion 471 and the second diffraction portion 472 are near-field diffractive optical elements that diffract the optical signal collected by the ball lens 41 toward the light collecting region. The transparent portion 475 is formed of a material that transmits light in a wavelength region of the optical signal. The transparent portion 475 may be implemented by an optical element that collects light in the wavelength region of the optical signal toward a light receiving element 431, or may be opened.

The optical element 47 has a shape bent in an arc shape with a first surface facing inward and a second surface facing outward, the second surface being opposite to the first surface. The optical element 47 is formed with a curvature based on the light collecting region formed around the ball lens 41. The optical element 47 is arranged between the ball lens 41 and the light receiving element array 43. The first surface of the optical element 47 is a light receiving surface. The first surface of the optical element 47 faces an emission surface of the ball lens 41. The second surface of the optical element 47 is an emission surface. The second surface of the optical element 47 faces a light receiving surface of the light receiving element array 43. The optical element 47 diffracts the optical signal collected by the ball lens 41 toward the light receiving element 431 included in the light receiving element array 43.

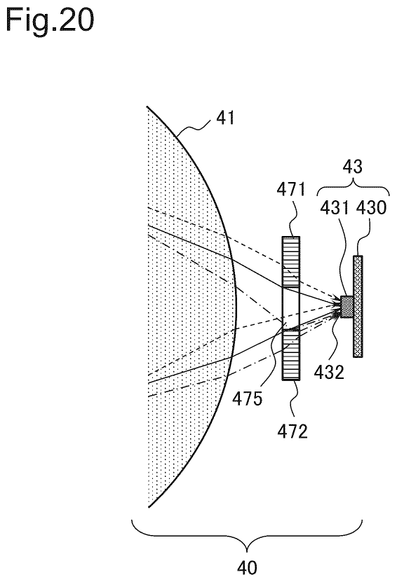

FIG. 20 is a cross-sectional view of a part of the light receiver 40 including the ball lens 41, the light receiving element array 43, and the optical element 47. FIG. 20 illustrates an example in which the light receiving elements 431 are arranged on an arc-shaped substrate 430. FIG. 20 illustrates a trajectory of light diffracted by the ball lens 41. The optical signal collected by the ball lens 41 in the light collecting region where the optical element 47 is arranged is diffracted by the optical element 47. The first diffraction portion 471 diffracts the optical signal incident on the light receiving surface of the optical element 47 from obliquely above toward any one of the light receiving elements 431 included in the light receiving element array 43. The second diffraction portion 472 diffracts the optical signal incident on the light receiving surface of the optical element 47 from obliquely below toward any one of the light receiving elements 431 included in the light receiving element array 43. The optical signal having passed through the transparent portion 475 travels toward any one of the light receiving elements 431 included in the light receiving element array 43. The optical signal diffracted by the optical element 47 is received by any one of the light receiving elements 431 included in the light receiving element array 43 arranged downstream of the optical element 47.

For example, in a case where a direction from which the spatial optical signal arrives at a surface formed by the light receiving element array 43 is limited to one direction, the optical element 47 may include only one of the first diffraction portion 471 and the second diffraction portion 472. For example, in a case where the spatial optical signal arrives from only above the surface formed by the light receiving element array 43, the spatial optical signal does not arrive from below, and thus, the optical element 47 may include only the first diffraction portion 471. For example, in a case where the spatial optical signal arrives only from below the surface formed by the light receiving element array 43, the spatial optical signal does not arrive from above, and thus, the optical element 47 may include only the second diffraction portion 472.

The light receiving element array 43 has the same configuration as the light receiving element array 13 of the first example embodiment. The light receiving element array 43 is arranged downstream of the optical element 47. The plurality of light receiving elements 431 included in the light receiving element array 43 each include a light receiving portion 432 that receives an optical signal derived from the spatial optical signal to be received. Each of the plurality of light receiving elements 431 is arranged in such a way that the light receiving portion 432 faces the emission surface of the optical element 47. Each of the plurality of light receiving elements 431 is arranged in such a way that the light receiving portion 432 is positioned at a position where it is easy to receive the optical signal diffracted by the optical element 47. The optical signal collected by the ball lens 41 is diffracted by the optical element 47 and received by the light receiving portion 432 of the light receiving element 431.

In the configuration of the first example embodiment, in a case where the spatial optical signal spreading in a direction parallel to a horizontal plane is received, an arc formed by the light receiving element array 13 is arranged to be substantially parallel to the horizontal plane. With such an arrangement, it is possible to cause each of the plurality of light receiving elements 131 to share the reception of the spatial optical signals arriving from various directions. However, in such an arrangement, since the spatial optical signal spreading in a direction perpendicular to the horizontal plane is incident while being shifted in the short side direction of the light receiving element array 13, it is difficult to efficiently receive the light. On the other hand, in the configuration of the present example embodiment, the optical signal incident while being shifted in a short side direction of the light receiving element array 43 is diffracted in the short side direction by the optical element 47. Therefore, with the configuration of the present example embodiment, the spatial optical signal spreading in the direction perpendicular to the horizontal plane is easily received as compared with the configuration of the first example embodiment.

Each of the plurality of light receiving elements 431 included in the light receiving element array 43 converts the received optical signal into an electric signal. Each of the plurality of light receiving elements 431 included in the light receiving element array 43 outputs the converted electric signal to the reception circuit 45. Although only one line (path) is illustrated between the light receiving element array 43 and the reception circuit 45 in FIG. 18, the light receiving element array 43 and the reception circuit 45 may be connected by a plurality of paths. For example, each of the plurality of light receiving elements 431 included in the light receiving element array 43 may be individually connected to the reception circuit 45. For example, each group of the plurality of light receiving elements 431 included in the light receiving element array 43 may be connected to the reception circuit 45.

The reception circuit 45 has the same configuration as the reception circuit 15 of the first example embodiment. The reception circuit 45 acquires a signal output from each of the plurality of light receiving elements 431 included in the light receiving element array 43. The reception circuit 45 amplifies the signal from each of the plurality of light receiving elements 431. The reception circuit 45 decodes the amplified signal and analyzes the signal from a communication target. The signal decoded by the reception circuit 45 is used for any purpose. The use of the signal decoded by the reception circuit 45 is not particularly limited.

### Modified Example 4

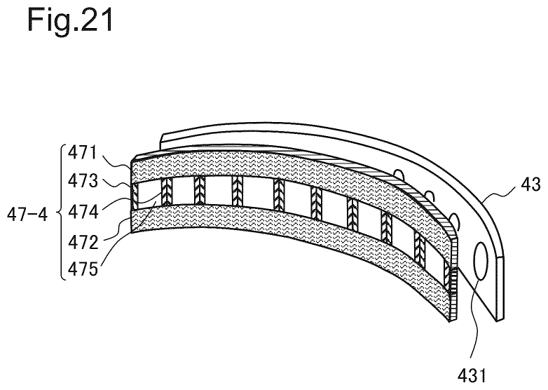

Next, a modified example (Modified Example 4) of the present example embodiment will be described with reference to the drawings. FIG. 21 is a conceptual view for explaining the present modified example. In FIG. 21, the ball lens 41 is omitted. A reception device of the present modified example includes an optical element 47-4 including a diffraction portion that diffracts an optical signal diffracted between light receiving portions 432 of two adjacent light receiving elements 431 toward the light receiving portion 432 of any one of the light receiving elements 431. FIG. 21 is a perspective view illustrating an example of a positional relationship between a light receiving element array 43 and the optical element 47-4. FIG. 21 is a perspective view of the optical element 47-4 viewed from a diagonally elevated perspective on an incident surface side. The light receiving element array 43 and the optical element 47-4 have a shape bent in an arc shape toward the center of the ball lens 41.

The optical element 47-4 (also referred to as a diffractive optical element) includes a first diffraction portion 471, a second diffraction portion 472, a third diffraction portion 473, a fourth diffraction portion 474, and a transparent portion 475. The first diffraction portion 471, the second diffraction portion 472, and the transparent portion 475 have a shape bent in an arc shape toward the center of the ball lens 41. The first diffraction portion 471 and the second diffraction portion 472 sandwich the transparent portion 475 from above and below. In the transparent portion 475, a plurality of third diffraction portions 473 and a plurality of fourth diffraction portions 474 are arranged in association with each of the plurality of light receiving elements 431.

The optical element 47-4 is arranged between the ball lens 41 and the light receiving element array 43. A first surface (light receiving surface) of the optical element 47-4 faces an emission surface of the ball lens 41. A second surface (emission surface) of the optical element 47-4 faces a light receiving surface of the light receiving element array 43. The optical element 47-4 diffracts the optical signal collected by the ball lens 41 toward the associated light receiving element 431.

The first diffraction portion 471 diffracts the optical signal incident on the light receiving surface of the optical element 47-4 from obliquely above toward the associated light receiving element 431. The second diffraction portion 472 diffracts the optical signal incident on the light receiving surface of the optical element 47-4 from obliquely below toward the associated light receiving element 431. Each of the plurality of third diffraction portions 473 is associated with each of the plurality of light receiving elements 431. Each of the plurality of third diffraction portions 473 is arranged on the left side of the associated light receiving element 431 on the light receiving surface of the optical element 47-4. The third diffraction portion 473 diffracts the optical signal incident from an obliquely left side of the light receiving surface of the optical element 47-4 toward the associated light receiving element 431. Each of the plurality of fourth diffraction portions 474 is associated with each of the plurality of light receiving elements 431. Each of the plurality of fourth diffraction portions 474 is arranged on the right side of the associated light receiving element 431 on the light receiving surface of the optical element 47-4. The fourth diffraction portion 474 diffracts the optical signal incident from an obliquely right side of the light receiving surface of the optical element 47-4 toward the associated light receiving element 431. The transparent portion 475 is divided by the plurality of third diffraction portions 473 and the plurality of fourth diffraction portions 474, and each divided portion thereof is associated with each of the plurality of light receiving elements 431. The optical signal having passed through the transparent portion 475 travels toward the associated light receiving element 431. The optical signal collected by the optical element 47-4 is received by any one of the light receiving elements 431 included in the light receiving element array 43 arranged downstream of the optical element 47-4.

The optical signal collected in a light collecting region where the optical element 47-4 is arranged by the ball lens 41 is diffracted by the first diffraction portion 471, the second diffraction portion 472, the third diffraction portion 473, and the fourth diffraction portion 474 or transmitted through the transparent portion 475. The optical signal guided by the optical element 47-4 is received by the light receiving element 431 arranged downstream of the optical element 47-4.

As the optical element 47-4 of the present modified example is used, the optical signal can be guided toward the light receiving element 431 also in the long side direction, similarly to the guidance in the short side direction of the light receiving element array 43. In a case of using the optical element 47, it is not possible to receive an optical signal incident on a non-sensitive region deviating from the light receiving element 431 while being diffracted toward the light receiving element array 43. The light collected in the non-sensitive region deviating from the light receiving element 431 can be guided to the light receiving element 431 by using the optical element 47-4 of the present modified example. That is, as the optical element 47-4 of the present modified example is used, light receiving efficiency for the optical signal can be improved as compared with a case of using the optical element 47.

As described above, the reception device of the present example embodiment includes the ball lens, the light receiving element array, the optical element, and the reception circuit. The ball lens collects an optical signal propagating in a space. The light receiving element array includes the plurality of light receiving elements that receive optical signals collected by the ball lens. The optical element is arranged between the ball lens and the light receiving element array. The optical element guides the optical signal collected by the ball lens toward the light receiving portion of any one of the light receiving elements included in the light receiving element array. For example, the optical element includes the diffractive optical element bent in an arc shape in a circumferential direction of the ball lens. The optical element diffracts the optical signal collected by the ball lens in a direction orthogonal to an arrangement direction of the light receiving element array, and guides the optical signal to the light receiving portion of any one of the light receiving elements included in the light receiving element array. The light receiving element array outputs signals derived from the optical signals received by the plurality of light receiving elements. The reception circuit decodes the signals output from the light receiving element array.

In the reception device according to the present example embodiment, the diffractive optical element bent in an arc shape with the flat surface facing outward in the circumferential direction of the ball lens diffracts an optical signal in a direction perpendicular to an arrangement direction of the plurality of light receiving elements. According to the present example embodiment, the optical element guides the optical signal deviating in a direction perpendicular to the arrangement direction of the plurality of light receiving elements toward the light receiving portion of the light receiving element, so that the light receiving efficiency for the optical signal can be improved.

### Fifth Example Embodiment

Next, a reception device according to a fifth example embodiment will be described with reference to the drawings. The reception device of the present example embodiment is different from the reception device of the first example embodiment in including a diffusion plate that diffuses signal light collected by a ball lens in a direction substantially perpendicular to a direction in which the signal light is refracted. The reception device of the present example embodiment may be combined with the configuration of the second example embodiment.

### Configuration

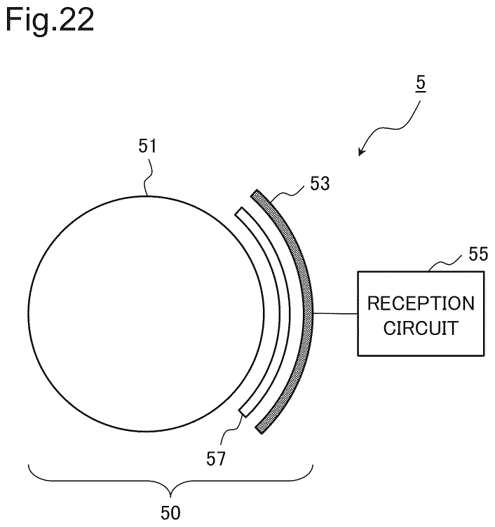

FIG. 22 is a conceptual view illustrating an example of a configuration of a reception device 5 according to the present example embodiment. The reception device 5 includes a ball lens 51, a light receiving element array 53, a reception circuit 55, and an optical element 57. The ball lens 51, the light receiving element array 53, and the optical element 57 are included in a light receiver 50. FIG. 22 is a plan view of the light receiver 50 as viewed from above.

The ball lens 51 has the same configuration as the ball lens 11 of the first example embodiment. The ball lens 51 collects a spatial optical signal arriving from the outside in a light collecting region of the ball lens 51.

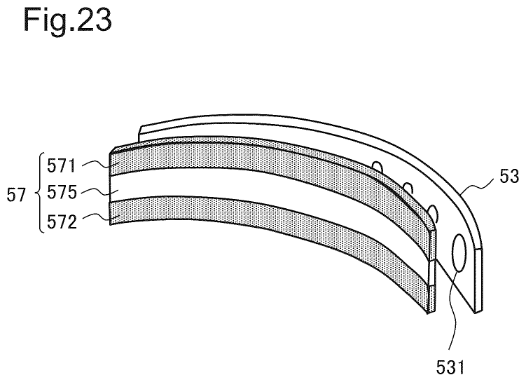

FIG. 23 is a perspective view illustrating an example of a positional relationship between the light receiving element array 53 and the optical element 57. FIG. 23 is a perspective view of the optical element 57 viewed from a diagonally elevated perspective on an incident surface side. The light receiving element array 53 and the optical element 57 have a shape bent in an arc shape toward the center of the ball lens 51.

The optical element 57 (also referred to as a diffusion plate) includes a first diffusion portion 571, a second diffusion portion 572, and a transparent portion 575. The first diffusion portion 571, the second diffusion portion 572, and the transparent portion 575 have a shape bent in an arc shape toward the center of the ball lens 51. The first diffusion portion 571 and the second diffusion portion 572 sandwich the transparent portion 575 from above and below. For example, the first diffusion portion 571 and the second diffusion portion 572 are diffusion plates that diffuse the optical signal collected by the ball lens 51. The transparent portion 575 is formed of a material that transmits light in a wavelength region of the optical signal. The transparent portion 575 may be implemented by an optical element that collects light in the wavelength region of the optical signal toward a light receiving element 531, or may be opened.

The optical element 57 has a shape bent in an arc shape with a first surface facing inward and a second surface facing outward, the second surface being opposite to the first surface. The optical element 57 is formed with a curvature based on the light collecting region formed around the ball lens 51. The optical element 57 is arranged between the ball lens 51 and the light receiving element array 53. The first surface of the optical element 57 is a light receiving surface. The first surface of the optical element 57 faces an emission surface of the ball lens 51. The second surface of the optical element 57 is an emission surface. The second surface of the optical element 57 faces a light receiving surface of the light receiving element array 53. The optical element 57 diffuses the optical signal collected by the ball lens 51 toward a range including the light receiving element 531 included in the light receiving element array 53.

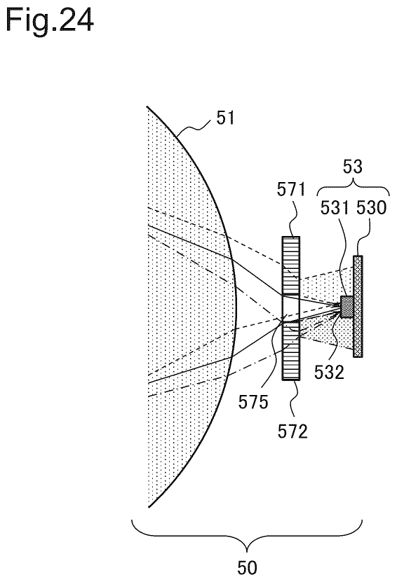

FIG. 24 is a cross-sectional view of a part of the light receiver 50 including the ball lens 51, the light receiving element array 53, and the optical element 57. FIG. 24 illustrates an example in which the light receiving elements 531 are arranged on an arc-shaped substrate 530. FIG. 24 illustrates a trajectory of light diffused by the ball lens 51. The optical signal collected by the ball lens 51 in the light collecting region where the optical element 57 is arranged is diffused by the optical element 57. The first diffusion portion 571 diffuses the optical signal incident on the light receiving surface of the optical element 57 from obliquely above toward a range including any one of the light receiving elements 531 included in the light receiving element array 53. The second diffusion portion 572 diffuses the optical signal incident on the light receiving surface of the optical element 57 from obliquely below toward the range including any one of the light receiving elements 531 included in the light receiving element array 53. The optical signal having passed through the transparent portion 575 travels toward any one of the light receiving elements 531 included in the light receiving element array 53. The optical signal diffused by the optical element 57 is received by any one of the light receiving elements 531 included in the light receiving element array 53 arranged downstream of the optical element 57.

For example, in a case where a direction from which the spatial optical signal arrives at a surface formed by the light receiving element array 53 is limited to one direction, the optical element 57 may include only one of the first diffusion portion 571 and the second diffusion portion 572. For example, in a case where the spatial optical signal arrives from only above the surface formed by the light receiving element array 53, the spatial optical signal does not arrive from below, and thus, the optical element 57 may include only the first diffusion portion 571. For example, in a case where the spatial optical signal arrives only from below the surface formed by the light receiving element array 53, the spatial optical signal does not arrive from above, and thus, the optical element 57 may include only the second diffusion portion 572.

The light receiving element array 53 has the same configuration as the light receiving element array 13 of the first example embodiment. The light receiving element array 53 is arranged downstream of the optical element 57. The plurality of light receiving elements 531 included in the light receiving element array 53 each include a light receiving portion 532 that receives an optical signal derived from the spatial optical signal to be received. Each of the plurality of light receiving elements 531 is arranged in such a way that the light receiving portion 532 faces the emission surface of the optical element 57. Each of the plurality of light receiving elements 531 is arranged in such a way that the light receiving portion 532 is positioned at a position where it is easy to receive the optical signal diffused by the optical element 57. The optical signal collected by the ball lens 51 is diffused by the optical element 57 and received by the light receiving portion 532 of the light receiving element 531.

In the configuration of the first example embodiment, in a case where the spatial optical signal spreading in a direction parallel to a horizontal plane is received, an arc formed by the light receiving element array 13 is arranged to be substantially parallel to the horizontal plane. With such an arrangement, it is possible to cause each of the plurality of light receiving elements 131 to share the reception of the spatial optical signals arriving from various directions. However, in such an arrangement, since the spatial optical signal spreading in a direction perpendicular to the horizontal plane is incident while being shifted in the short side direction of the light receiving element array 13, it is difficult to efficiently receive the light. On the other hand, in the configuration of the present example embodiment, the optical signal incident while being shifted in a short side direction of the light receiving element array 53 is diffused in the short side direction by the optical element 57. Therefore, with the configuration of the present example embodiment, the spatial optical signal spreading in the direction perpendicular to the horizontal plane is easily received as compared with the configuration of the first example embodiment. The configuration of the present example embodiment can improve the light receiving efficiency with a simple configuration as compared with the configuration of the first example embodiment.

Each of the plurality of light receiving elements 531 included in the light receiving element array 53 converts the received optical signal into an electric signal. Each of the plurality of light receiving elements 531 included in the light receiving element array 53 outputs the converted electric signal to the reception circuit 55. Although only one line (path) is illustrated between the light receiving element array 53 and the reception circuit 55 in FIG. 22, the light receiving element array 53 and the reception circuit 55 may be connected by a plurality of paths. For example, each of the plurality of light receiving elements 531 included in the light receiving element array 53 may be individually connected to the reception circuit 55. For example, each group of the plurality of light receiving elements 531 included in the light receiving element array 53 may be connected to the reception circuit 55.

The reception circuit 55 has the same configuration as the reception circuit 15 of the first example embodiment. The reception circuit 55 acquires a signal output from each of the plurality of light receiving elements 531 included in the light receiving element array 53. The reception circuit 55 amplifies the signal from each of the plurality of light receiving elements 531. The reception circuit 55 decodes the amplified signal and analyzes the signal from a communication target. The signal decoded by the reception circuit 55 is used for any purpose. The use of the signal decoded by the reception circuit 55 is not particularly limited.

### Modified Example 5

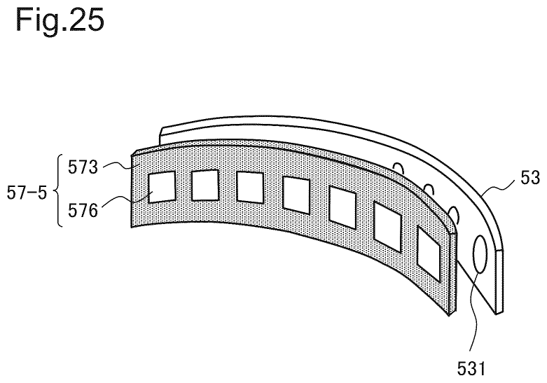

Next, a modified example (Modified Example 5) of the present example embodiment will be described with reference to the drawings. FIG. 25 is a conceptual view for explaining the present modified example. In FIG. 25, the ball lens 51 is omitted. A reception device of the present modified example includes an optical element 57-5 that diffuses an optical signal diffused between light receiving portions 532 of two adjacent light receiving elements 531 toward the light receiving portion 532 of any one of the light receiving elements 531. FIG. 25 is a perspective view illustrating an example of a positional relationship between a light receiving element array 53 and the optical element 57-5. FIG. 25 is a perspective view of the optical element 57-5 viewed from a diagonally elevated perspective on an incident surface side. The light receiving element array 53 and the optical element 57-5 have a shape bent in an arc shape toward the center of the ball lens 51.

The optical element 57-5 (also referred to as a diffusion plate) includes a diffusion portion 573 and a transparent portion 576. The diffusion portion 573 has a shape bent in an arc shape toward the center of the ball lens 51. The transparent portion 576 is provided in the diffusion portion 573 in association with each of the plurality of light receiving elements 531.

The optical element 57-5 is arranged between the ball lens 51 and the light receiving element array 53. A first surface (light receiving surface) of the optical element 57-5 faces an emission surface of the ball lens 51. A second surface (emission surface) of the optical element 57-5 faces a light receiving surface of the light receiving element array 53. The optical element 57-5 diffuses the optical signal collected by the ball lens 51 toward a range including the light receiving element 531.

The diffusion portion 573 diffuses the optical signal incident on the light receiving surface of the optical element 57-5 toward a range including the light receiving element array 53. The optical signal having passed through the transparent portion 576 travels toward the associated light receiving element 531. The optical signal collected by the optical element 57-5 is received by any one of the light receiving elements 531 included in the light receiving element array 53 arranged downstream of the optical element 57-5.

The optical signal collected by the ball lens 51 in a light collecting region where the optical element 57-5 is arranged is diffused by the diffusion portion 573 or transmitted through the transparent portion 575. The optical signal guided by the optical element 57-5 is received by the light receiving element 531 arranged downstream of the optical element 57-5.

As the optical element 57-5 of the present modified example is used, even an optical signal diffused in a non-sensitive region between adjacent light receiving elements 531 can be guided toward the light receiving element 531. In a case of using the optical element 57, it is not possible to receive the optical signal incident on the non-sensitive region deviating from the light receiving element 531 while being diffused in a range of the light receiving element array 53. A part of the light collected in the non-sensitive region deviating from the light receiving element 531 can be guided to the light receiving element 531 by using the optical element 57-5 of the present modified example. That is, as the optical element 57-5 of the present modified example is used, light receiving efficiency for the optical signal can be improved as compared with a case of using the optical element 57.

As described above, the reception device of the present example embodiment includes the ball lens, the light receiving element array, the optical element, and the reception circuit. The ball lens collects an optical signal propagating in a space. The light receiving element array includes the plurality of light receiving elements that receive optical signals collected by the ball lens. The optical element is arranged between the ball lens and the light receiving element array. The optical element guides the optical signal collected by the ball lens toward the light receiving portion of any one of the light receiving elements included in the light receiving element array. For example, the optical element includes the diffusion plate bent in an arc shape in a circumferential direction of the ball lens. The optical element diffuses the optical signal collected by the ball lens and guides the optical signal toward the light receiving portion of any one of the light receiving elements included in the light receiving element array. The light receiving element array outputs signals derived from the optical signals received by the plurality of light receiving elements. The reception circuit decodes the signals output from the light receiving element array.

In the reception device according to the present example embodiment, the diffusion plate bent in an arc shape in the circumferential direction of the ball lens diffuses the optical signal. According to the present example embodiment, the optical element guides the optical signal deviating in a direction perpendicular to the arrangement direction of the plurality of light receiving elements toward the light receiving portion of the light receiving element, so that the light receiving efficiency for the optical signal can be improved.

Any combination of the optical elements of the third to fifth example embodiment is possible. For example, the optical element of the first example embodiment may be disposed in the transparent portion of the optical element of each of the fourth and fifth example embodiments. For example, for the surface formed by the light receiving element array, the optical element of the fourth example embodiment may be used for the spatial optical signal arriving from above, and the optical element of the fifth example embodiment may be used for the spatial optical signal arriving from below. For example, the optical element may be configured by stacking the optical elements of the third to fifth example embodiments in a minor axis direction in an arbitrary order.

### Sixth Example Embodiment

Next, a reception device according to a sixth example embodiment will be described with reference to the drawings. The reception device of the present example embodiment is different from the reception device of the first example embodiment in including a reflection structure that reflects an optical signal collected at a position deviating from a light receiving portion of a light receiving element toward the light receiving portion. The reception device of the present example embodiment may be combined with the configurations of the second to fifth example embodiments.

### Configuration

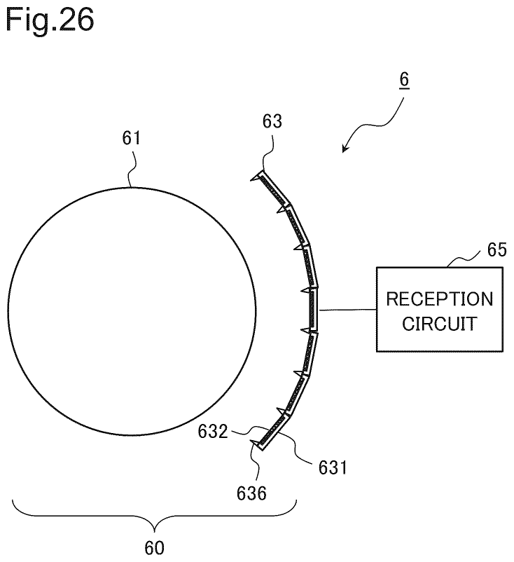

FIG. 26 is a conceptual view illustrating an example of a configuration of a reception device 6 according to the present example embodiment. The reception device 6 includes a ball lens 61, a light receiving element array 63, and a reception circuit 65. The ball lens 61 and the light receiving element array 63 are included in a light receiver 60. FIG. 26 is a plan view of the light receiver 60 as viewed from above.

The ball lens 61 has the same configuration as the ball lens 11 of the first example embodiment. The ball lens 61 collects a spatial optical signal arriving from the outside in a light collecting region of the ball lens 61.

The light receiving element array 63 includes a plurality of light receiving elements 631 arranged in an arc shape in a circumferential direction of the ball lens 61. Each of the plurality of light receiving elements 631 included in the light receiving element array 63 has the same configuration as the light receiving element 131 of the first example embodiment. The number of light receiving elements included in the light receiving element array 63 is not limited. The light receiving element array 63 includes a reflection structure 636. The reflection structure 636 is installed in association with each of the plurality of light receiving elements 631.

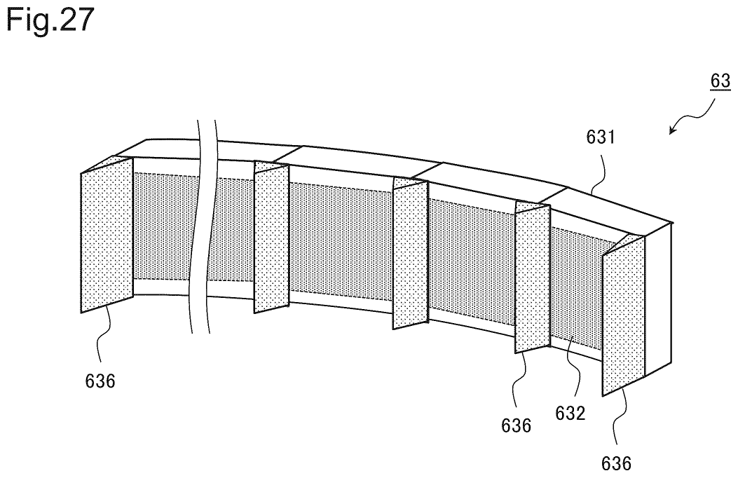

The reflection structure 636 is arranged in a non-sensitive region of a light receiving surface of the light receiving element 631. The non-sensitive region is a portion of the light receiving surface of the light receiving element 631 where a light receiving portion 632 is not exposed. FIG. 27 is a conceptual view illustrating an installation example of the reflection structure 636. FIG. 27 is a perspective view of the light receiving element array 63 viewed from a diagonally elevated perspective on an incident surface side. In the example of FIG. 27, a common reflection structure 636 is installed in the non-sensitive region between the light receiving portions 632 of two adjacent light receiving elements 631. In addition, dedicated reflection structures 636 are installed on the light receiving elements 631 at both ends of the light receiving element array 63. The plurality of reflection structures 636 may have the same shape or different shapes. The reflection structure 636 may be installed in each of non-sensitive regions on upper and lower sides of the light receiving element 631.

For example, the reflection structure 636 is formed of plastic, glass, silicon, metal, or the like as a base material. For example, a reflection surface of the reflection structure 636 is formed by plating, vapor deposition, polishing, or the like. For example, the reflection structure 636 can be formed by depositing aluminum on glass. For example, the reflection structure 636 may be bonded to a frame formed of metal such as aluminum, and fixed to the non-sensitive region around the light receiving portion 632 of the light receiving element 631. The material of the reflection structure 636 and the property of the reflection surface are not particularly limited as long as an incident optical signal can be reflected toward the light receiving portion 632.

The light receiving element array 63 is arranged downstream of the ball lens 61. The plurality of light receiving elements 631 each include the light receiving portion 632 that receives an optical signal derived from the spatial optical signal to be received. Each of the plurality of light receiving elements 631 is arranged in such a way that a light receiving portion 632 faces an emission surface of the ball lens 61. Each of the plurality of light receiving elements 631 is arranged in such a way that the light receiving portion 632 is positioned in the light collecting region of the ball lens 61. The optical signal collected by the ball lens 61 is received by the light receiving portion 632 of the light receiving element 631 positioned in the light collecting region. A component of the optical signal collected by the ball lens 61 is directly received by the light receiving portion 632, the component being incident on the light receiving portion 632 of the light receiving element 631. A component of the optical signal collected by the ball lens 61 is reflected by the reflection surface of the reflection structure 636, guided to the light receiving portion 632, and received by the light receiving portion 632, the component being incident on the non-sensitive region of the light receiving element 631.

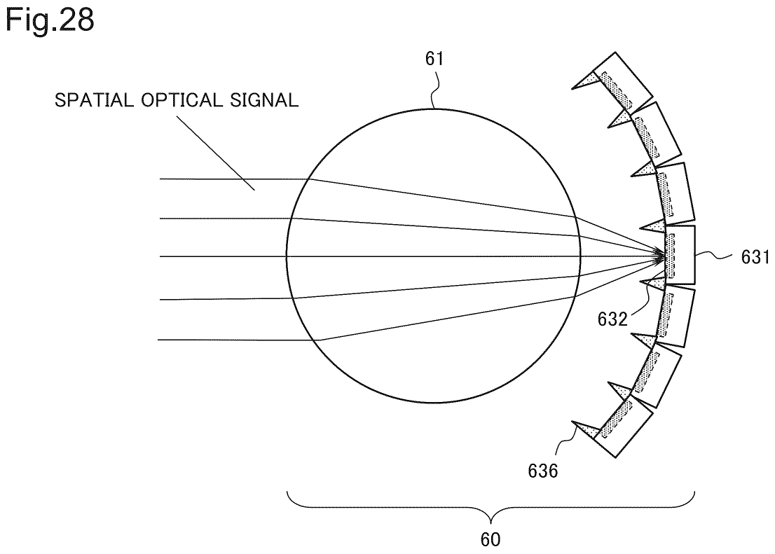

FIG. 28 is a conceptual view for explaining an example of a trajectory of the spatial optical signal incident on the light receiver 60. FIG. 28 illustrates a trajectory of light collected by the ball lens 61. In the example of FIG. 28, the optical signal collected by the ball lens 61 in the light collecting region where the light receiving element array 63 is arranged is incident on the light receiving portion 632 of one light receiving element 631. In the example of FIG. 28, the optical signal collected in the light collecting region where the light receiving element array 63 is arranged is received by one light receiving element 631.

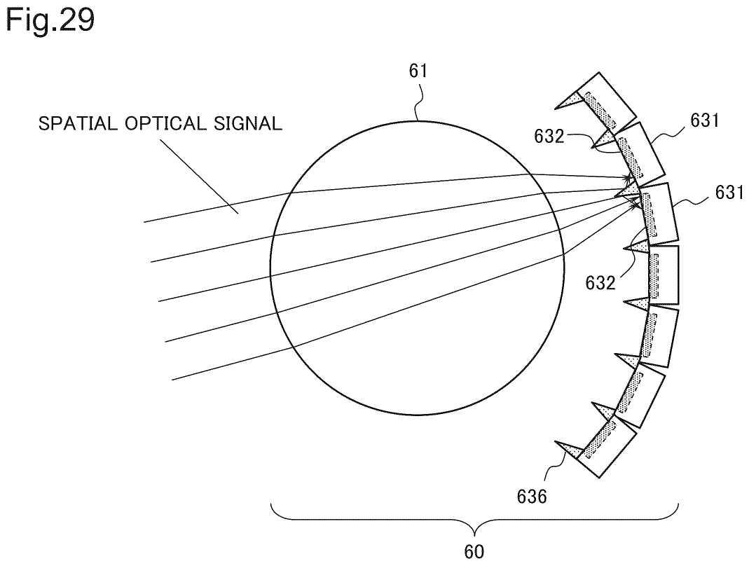

FIG. 29 is a conceptual view for explaining another example of the trajectory of the spatial optical signal incident on the light receiver 60. FIG. 29 illustrates a trajectory of light collected by the ball lens 61. In the example of FIG. 29, the optical signal collected by the ball lens 61 in the light collecting region where the light receiving element array 63 is arranged is incident on the light receiving portions 632 of two adjacent light receiving elements 631. A component of the optical signal collected by the ball lens 61 is directly received by the light receiving portion 632, the component being incident on the light receiving portion 632 of the light receiving element 631. A component of the optical signal collected by the ball lens 61 is reflected by the reflection surface of the reflection structure 636, guided to the light receiving portion 632, and received by the light receiving portion 632, the component being incident on the non-sensitive region of the light receiving element 631. In the example of FIG. 29, the optical signal collected in the light collecting region where the light receiving element array 63 is arranged is received by the two adjacent light receiving elements 631.

Each of the plurality of light receiving elements included in the light receiving element array 63 converts the received optical signal into an electric signal. Each of the plurality of light receiving elements included in the light receiving element array 63 outputs the converted electric signal to the reception circuit 65. Although only one line (path) is illustrated between the light receiving element array 63 and the reception circuit 65 in FIG. 26, the light receiving element array 63 and the reception circuit 65 may be connected by a plurality of paths. For example, each of the light receiving elements 631 included in the light receiving element array 63 may be individually connected to the reception circuit 65. For example, each group of the light receiving elements 631 included in the light receiving element array 63 may be connected to the reception circuit 65.

In the configuration of the first example embodiment, the optical signal collected in the non-sensitive region of the light receiving surface of the light receiving element 131 is not received. On the other hand, in the configuration of the present example embodiment, the optical signal collected in the non-sensitive region of the light receiving surface of the light receiving element 631 is reflected by the reflection surface of the reflection structure 636 and guided to the light receiving portion 632. Therefore, with the configuration of the present example embodiment, a received light intensity of the spatial optical signal is increased as compared with the configuration of the first example embodiment.

The reception circuit 65 has the same configuration as the reception circuit 15 of the first example embodiment. The reception circuit 65 acquires a signal output from each of the plurality of light receiving elements 631 included in the light receiving element array 63. The reception circuit 65 amplifies the signal from each of the plurality of light receiving elements 631. The reception circuit 65 decodes the amplified signal and analyzes the signal from a communication target. The signal decoded by the reception circuit 65 is used for any purpose. The use of the signal decoded by the reception circuit 65 is not particularly limited.

As described above, the reception device of the present example embodiment includes the ball lens, the light receiving element array, the reflection structure, and the reception circuit. The ball lens collects an optical signal propagating in a space. The light receiving element array includes the plurality of light receiving elements that receive optical signals collected by the ball lens. The optical element is arranged between the ball lens and the light receiving element array. The reflection structure is arranged in the non-sensitive region of each of the plurality of light receiving elements. The reflection structure reflects the optical signal emitted from the ball lens toward the light receiving portion of the light receiving element. The light receiving element array outputs signals derived from the optical signals received by the plurality of light receiving elements. The reception circuit decodes the signals output from the light receiving element array.

In the reception device of the present example embodiment, the reflection structure reflects, toward the light receiving portion, the optical signal deviating to the non-sensitive region of the light receiving element. According to the present example embodiment, the reflection structure reflects, toward the light receiving portion of the light receiving element, the optical signal deviating to the non-sensitive region of the light receiving element, and thus, the light receiving efficiency for the optical signal can be improved.

### Seventh Example Embodiment

Next, a communication device according to a seventh example embodiment will be described with reference to the drawings. The communication device according to the present example embodiment includes the reception device according to any one of the first to sixth example embodiments and a transmission device that transmits a spatial optical signal based on a received spatial optical signal. Hereinafter, an example of a communication device including a transmission device including a phase-modulation-type spatial light modulator will be described. The communication device of the present example embodiment may include a transmission device having a light transmission function that is not a phase-modulation-type spatial light modulator.

### Configuration

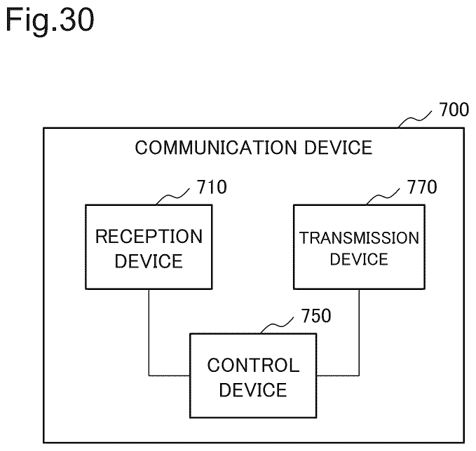

FIG. 30 is a conceptual view illustrating an example of a configuration of a communication device 700 according to the present example embodiment. The communication device 700 includes a reception device 710, a control device 750, and a transmission device 770. The reception device 710 and the transmission device 770 transmit and receive a spatial optical signal to and from an external communication target. Therefore, an opening or a window for transmitting and receiving a spatial optical signal is formed in the communication device 700.

The reception device 710 is the reception device according to any one of the first to sixth example embodiments. The reception device 710 may be a reception device having a configuration in which the first to sixth example embodiments are combined. The reception device 710 receives a spatial optical signal transmitted from a communication target (not illustrated). The reception device 710 converts the received spatial optical signal into an electric signal. The reception device 710 outputs the converted electric signal to the control device 750.

The control device 750 acquires a signal output from the reception device 710. The control device 750 executes processing according to the acquired signal. The processing executed by the control device 750 is not particularly limited. The control device 750 outputs a control signal for transmitting an optical signal associated to the executed processing to the transmission device 770.

The transmission device 770 acquires the control signal from the control device 750. The transmission device 770 projects a spatial optical signal relevant to the control signal. The spatial optical signal projected from the transmission device 770 is received by the communication target (not illustrated). For example, the transmission device 770 includes a phase-modulation-type spatial light modulator. The transmission device 770 may have a light transmission function that is not a phase-modulation-type spatial light modulator.

### [Transmission Device]

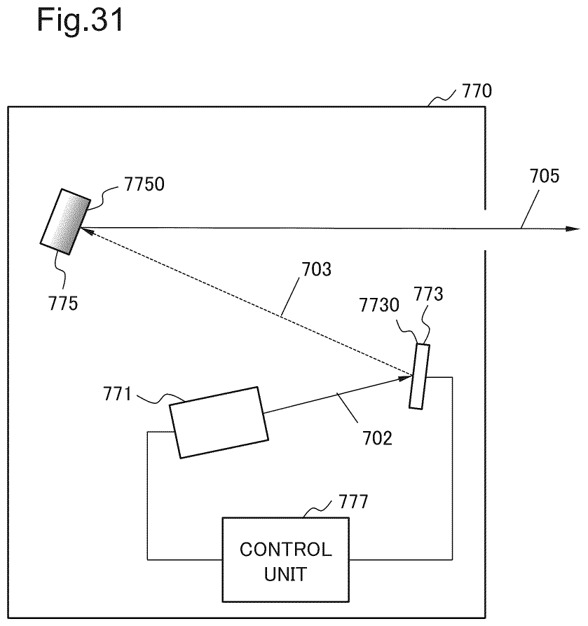

FIG. 31 is a conceptual view illustrating an example of a configuration of the transmission device 770. The transmission device 770 includes a light source 771, a spatial light modulator 773, a curved mirror 775, and a control unit 777. The light source 771, the spatial light modulator 773, and the curved mirror 775 are included in a transmission unit. FIG. 31 is a side view of an internal configuration of the transmission device 770 as viewed from a lateral direction. FIG. 31 is a conceptual view and does not accurately represent a positional relationship between the components, a traveling direction of light, and the like.

The light source 771 emits laser light in a predetermined wavelength band under the control of the control unit 777. The wavelength of the laser light emitted from the light source 771 is not particularly limited and may be selected depending on the use. For example, the light source 771 emits laser light in a visible or infrared wavelength band. For example, in a case of a near-infrared ray of 800 to 900 nanometers (nm), since a laser class can be increased, sensitivity can be improved by about one digit as compared with other wavelength bands. For example, a high-output laser light source can be used for an infrared ray in a wavelength band of 1.55 micrometers (μm). As a laser light source of an infrared ray in a wavelength band of 1.55 μm, an aluminum gallium arsenide phosphide (AlGaAsP)-based laser light source, an indium gallium arsenide (InGaAs)-based laser light source, or the like can be used. The longer the wavelength of the laser light is, the larger the diffraction angle can be made and the higher the energy can be set. The light source 771 includes a lens that expands laser light in accordance with a size of a modulation portion 7730 of the spatial light modulator 773. The light source 771 emits light 702 expanded by the lens. The light 702 emitted from the light source 771 travels toward the modulation portion 7730 of the spatial light modulator 773.

The spatial light modulator 773 includes the modulation portion 7730 irradiated with the light 702. The modulation portion 7730 of the spatial light modulator 773 is irradiated with the light 702 emitted from the light source 771. In the modulation portion 7730 of the spatial light modulator 773, a pattern (also referred to as a phase image) associated to an image displayed by projected light 705 is set under the control of the control unit 777. The light 702 incident on the modulation portion 7730 of the spatial light modulator 773 is modulated according to the pattern set in the modulation portion 7730 of the spatial light modulator 773. Modulated light 703 modulated by the modulation portion 7730 of the spatial light modulator 773 travels toward a reflection surface 7750 of the curved mirror 775.

For example, the spatial light modulator 773 is implemented by a spatial light modulator using ferroelectric liquid crystal, homogeneous liquid crystal, vertical alignment liquid crystal, or the like. For example, the spatial light modulator 773 can be implemented by liquid crystal on silicon (LCOS). The spatial light modulator 773 may be implemented by a micro electro mechanical system (MEMS). In the phase-modulation-type spatial light modulator 773, energy can be concentrated on the image by operating in such a way as to sequentially switch a portion on which the projected light 705 is to be projected. Therefore, in a case of using the phase-modulation-type spatial light modulator 773, if an output of the light source 771 is the same, the image can be displayed brighter as compared with those in a case of using other methods.

The modulation portion 7730 of the spatial light modulator 773 is divided into a plurality of regions (also referred to as tiling). For example, the modulation portion 7730 is divided into rectangular regions (also referred to as tiles) having a desired aspect ratio. The phase image is assigned to each of the plurality of tiles set in the modulation portion 7730. Each of the plurality of tiles includes a plurality of pixels. The phase image associated to the projected image is set for each of the plurality of tiles. The phase images set for the plurality of tiles may be the same or different.

The phase image is tiled for each of the plurality of tiles assigned to the modulation portion 7730. For example, a phase image generated in advance is set for each of the plurality of tiles. When the modulation portion 7730 is irradiated with the light 702 in a state where the phase images are set for the plurality of tiles, the modulated light 703 that forms an image associated to the phase image of each tile is emitted. As the number of tiles set in the modulation portion 7730 increases, a clear image can be displayed. However, when the number of pixels of each tile decreases, the resolution decreases. Therefore, the size and number of tiles set in the modulation portion 7730 are set depending on the use.

The curved mirror 775 is a reflecting mirror having the curved reflection surface 7750. The reflection surface 7750 of the curved mirror 775 has a curvature based on a projection angle of the projected light 705. The reflection surface 7750 of the curved mirror 775 is only required to be a curved surface. In the example of FIG. 31, the reflection surface 7750 of the curved mirror 775 has a shape of a side surface of a cylinder. For example, the reflection surface 7750 of the curved mirror 775 may be a spherical surface. For example, the reflection surface 7750 of the curved mirror 775 may be a free-form surface. For example, the reflection surface 7750 of the curved mirror 775 may have a shape in which a plurality of curved surfaces are combined, instead of a single curved surface. For example, the reflection surface 7750 of the curved mirror 775 may have a shape in which a curved surface and a flat surface are combined.

The curved mirror 775 is arranged on an optical path of the modulated light 703 with the reflection surface 7750 facing the modulation portion 7730 of the spatial light modulator 773. The reflection surface 7750 of the curved mirror 775 is irradiated with the modulated light 703 modulated by the modulation portion 7730 of the spatial light modulator 773. The light (projected light 705) reflected by the reflection surface 7750 of the curved mirror 775 is expanded at an expansion ratio based on the curvature of the reflection surface 7750 and projected. In the example of FIG. 31, the projected light 705 is expanded in a horizontal direction (a direction perpendicular to a plane of FIG. 31) according to a curvature of an irradiation range of the modulated light 703 on the reflection surface 7750 of the curved mirror 775.

For example, a shield (not illustrated) may be arranged between the spatial light modulator 773 and the curved mirror 775. In other words, the shield may be arranged on an optical path of the modulated light 703 modulated by the modulation portion 7730 of the spatial light modulator 773. The shield is a frame that blocks unnecessary light components included in the modulated light 703 and defines an outer edge of a display region of the projected light 705. For example, the shield is an aperture in which a slit-shaped opening is formed at a portion through which light that forms a desired image passes. The shield passes light that forms a desired image and blocks unnecessary light components. For example, the shield blocks 0th-order light or a ghost image included in the modulated light 703. A detail description of the shield will be omitted.

The control unit 777 controls the light source 771 and the spatial light modulator 773. For example, the control unit 777 is implemented by a microcomputer including a processor and a memory. The control unit 777 sets a phase image associated to the projected image in the modulation portion 7730 according to the aspect ratio of tiling set in the modulation portion 7730 of the spatial light modulator 773. For example, the control unit 777 sets, in the modulation portion 7730, a phase image associated to an image for the use such as image display, communication, or distance measurement. The phase image of the projected image may be stored in advance in a storage unit (not illustrated). The shape and size of the projected image are not particularly limited.

The control unit 777 drives the spatial light modulator 773 in such a way that a parameter that determines a difference between a phase of the light 702 emitted to the modulation portion 7730 of the spatial light modulator 773 and a phase of the modulated light 703 reflected by the modulation portion 7730 changes. The parameter that determines the difference between the phase of the light 702 emitted to the modulation portion 7730 of the spatial light modulator 773 and the phase of the modulated light 703 reflected by the modulation portion 7730 is, for example, a parameter regarding optical characteristics such as a refractive index and an optical path length. For example, the control unit 777 adjusts the refractive index of the modulation portion 7730 by changing a voltage applied to the modulation portion 7730 of the spatial light modulator 773. A phase distribution of the light 702 emitted to the modulation portion 7730 of the phase-modulation-type spatial light modulator 773 is modulated according to the optical characteristics of the modulation portion 7730. A method for driving the spatial light modulator 773 by the control unit 777 is determined according to a modulation scheme of the spatial light modulator 773.

The control unit 777 drives the light source 771 in a state where the phase image associated to the image to be displayed is set in the modulation portion 7730. As a result, the light 702 emitted from the light source 771 is emitted to the modulation portion 7730 of the spatial light modulator 773 at a timing at which the phase image is set in the modulation portion 7730 of the spatial light modulator 773. The light 702 emitted to the modulation portion 7730 of the spatial light modulator 773 is modulated by the modulation portion 7730 of the spatial light modulator 773. The modulated light 703 modulated by the modulation portion 7730 of the spatial light modulator 773 is emitted toward the reflection surface 7750 of the curved mirror 775.

For example, the curvature of the reflection surface 7750 of the curved mirror 775 included in the transmission device 770 and a distance between the spatial light modulator 773 and the curved mirror 775 are adjusted, and a projection angle of the projected light 705 is set to 180 degrees. By using two transmission devices 770 configured as described above, the projection angle of the projected light 705 can be set to 360 degrees. If a part of the modulated light 703 is reflected by a plane mirror or the like inside the transmission device 770 so that the projected light 705 is projected in two directions, the projection angle of the projected light 705 can be set to 360 degrees. For example, the transmission device 770 configured to project the projected light in a direction of 360 degrees and the reception device 2 of the second example embodiment are combined. With such a configuration, it is possible to implement a communication device that transmits the spatial optical signal in a direction of 360 degrees and receives the spatial optical signal arriving from a direction of 360 degrees.

### [Communication System]

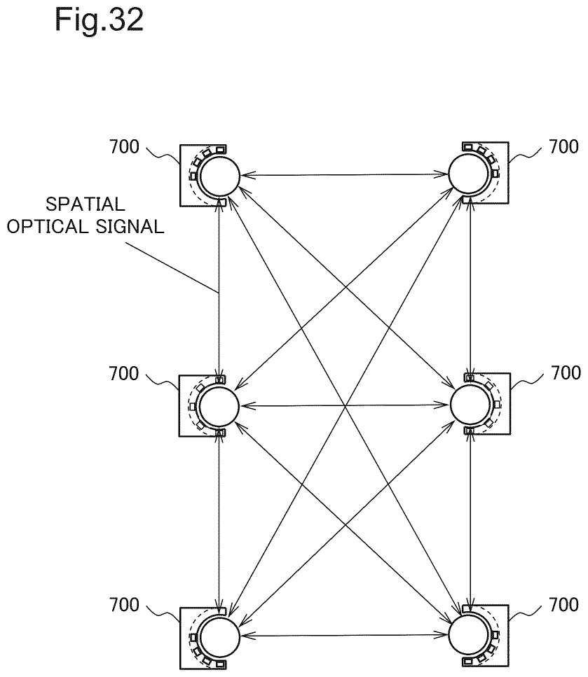

Next, a communication system using the communication device of the present example embodiment will be described with reference to the drawings. FIG. 32 is a conceptual view illustrating an example of a configuration of the communication system using a communication device 700. The communication device 700 has a configuration similar to that of the communication device 700. FIG. 32 illustrates an example in which spatial optical signals are transmitted and received between a plurality of communication devices 700 arranged in a mesh shape on a plane parallel to a horizontal plane. In a case of the configuration of FIG. 32, there are communication devices 700 arranged at corners of a rectangle forming a communication network and communication devices 700 arranged on sides of the rectangle.

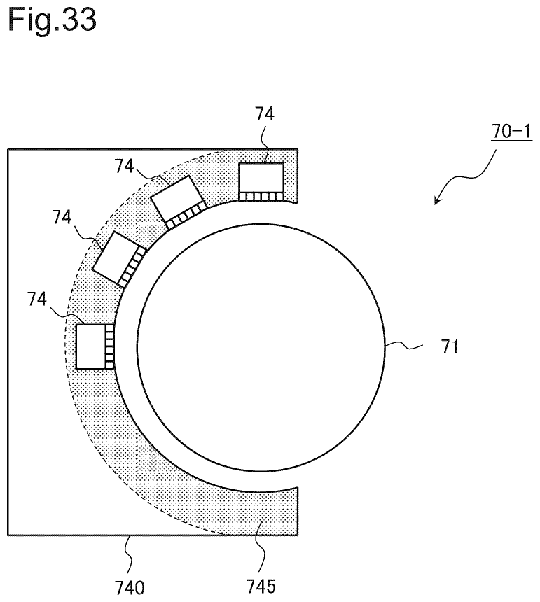

FIG. 33 is a conceptual view illustrating an example of a configuration of a light receiver 70-1 of the communication device 700 arranged at the corner of the rectangle forming the communication network. The light receiver 70-1 includes a plurality of light receiving units 74. The light receiving unit 74 has a configuration in which the light receiving element array and the reception circuit of each example embodiment are combined. A plurality of light receiving units 74 are arranged on one surface of a substrate 740 having a cut-out portion where a ball lens 71 is arranged. The plurality of light receiving units 74 are arranged in such a way that light receiving surfaces face the ball lens 71. For example, each of the plurality of light receiving units 74 is fixed to the substrate 740 by a method such as screwing. The light receiving unit 74 can be detached from the substrate 740 and can be fixed at any position within a range of a unit arrangement region 745 of the substrate 740.

The communication device 700 arranged at the corner of the rectangle forming the communication network receives a spatial optical signal arriving from a direction of 90 degrees on a plane formed by the plurality of communication devices 700. Therefore, the light receiving units 74 of the light receiver 70-1 are intensively arranged within a range of 90 degrees in such a way that the light receiving surfaces face the communication device 700 that is a communication target. The plurality of light receiving units 74 may be arranged in accordance with an arrival direction of the spatial optical signal.

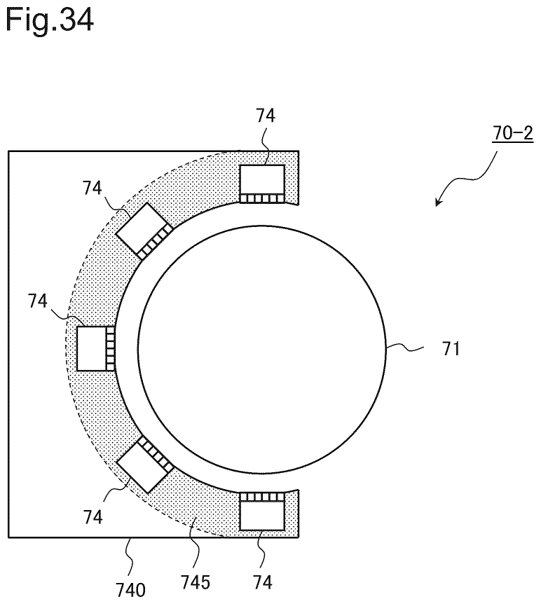

FIG. 34 is a conceptual view illustrating an example of a configuration of a light receiver 70-2 of the communication device 700 arranged on the side of the rectangle forming the communication network. The light receiver 70-2 includes a plurality of light receiving units 74. The light receiving unit 74 has a configuration in which the light receiving element array and the reception circuit of each example embodiment are combined. A plurality of light receiving units 74 are arranged on one surface of a substrate 740 having a cut-out portion where a ball lens 71 is arranged. The plurality of light receiving units 74 are arranged in such a way that light receiving surfaces face the ball lens 71. For example, each of the plurality of light receiving units 74 is fixed to the substrate 740 by a method such as screwing. With this configuration, the communication devices 700 arranged at the sides and corners of the rectangle forming the communication network can be implemented with the same specifications.

The communication device 700 arranged on the side of the rectangle forming the communication network receives a spatial optical signal arriving from a direction of 180 degrees on the plane formed by the plurality of communication devices 700. Therefore, the light receiving units 74 of the light receiver 70-2 are dispersedly arranged within a range of 180 degrees in such a way that the light receiving surfaces face the communication device 700 that is a communication target. The plurality of light receiving units 74 may be arranged in accordance with an arrival direction of the spatial optical signal.

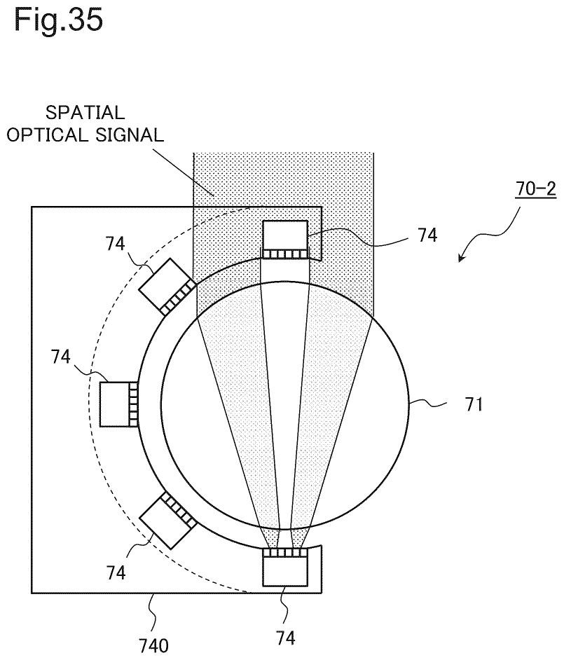

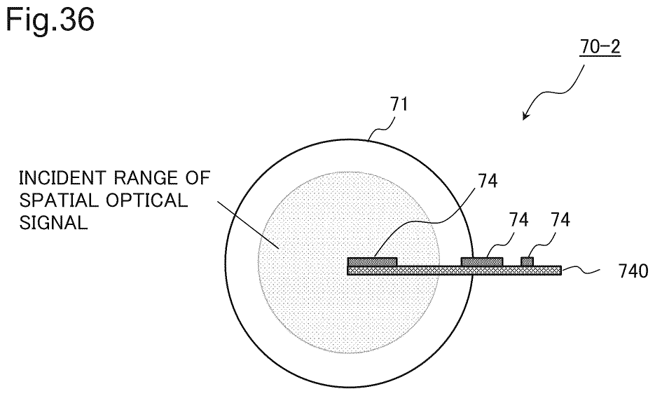

FIGS. 35 and 36 are conceptual views illustrating a state in which the spatial optical signal is incident on the light receiver 70-2 of the communication device 700. FIG. 35 is a view of the light receiver 70-2 viewed from an overhead perspective. FIG. 36 is a view of the light receiver 70-2 from an opposite perspective of the arrival direction of the spatial optical signal. The plurality of light receiving units 74 included in the communication device 700 are dispersedly arranged. The spatial optical signal arrives in an irradiation range larger than a width of the light receiving unit 74. Therefore, the light receiving unit 74 arranged on the lower side of FIG. 35 can receive the spatial optical signal collected by the ball lens 71 although arrival of the spatial optical signal is hindered by the light receiving unit 74 opposite thereto.

### Application Example 1

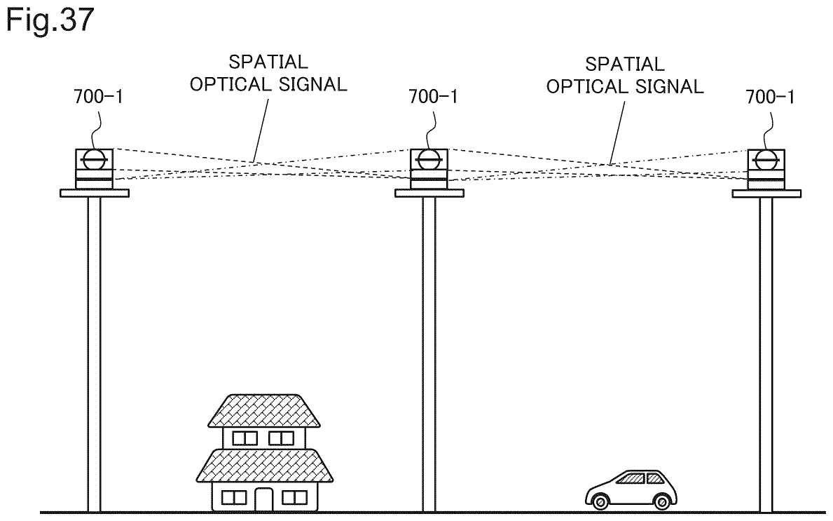

Next, Application Example 1 of the communication device according to the present example embodiment will be described with reference to the drawings. FIG. 37 is a conceptual view for explaining the present application example. In the present application example, a communication network in which a plurality of communication devices 700-1 are arranged on poles such as utility poles or street lamps is configured. The communication device 700-1 has a configuration similar to that of the communication device 700.

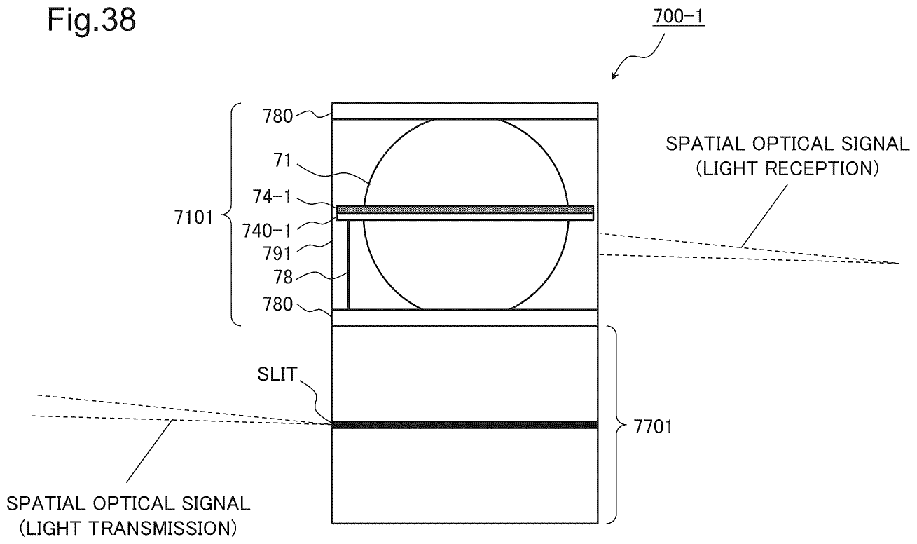

FIG. 38 is a conceptual view illustrating an example of the configuration of the communication device 700-1. The communication device 700-1 includes a light receiver 7101, a transmitter 7701, and a control device (not illustrated). In FIG. 38, a light reception circuit and the control device are omitted. The communication device 700-1 has a cylindrical outer shape. The light receiver 7101 includes a ball lens 71, a light receiving unit 74-1, a substrate 740, a plate-like element 780, and a color filter 790-1. The ball lens 71 is sandwiched between a pair of plate-like elements 780 arranged above and below the ball lens 71. Upper and lower portions of the ball lens 71 are not used for transmitting and receiving a spatial optical signal, and thus may be formed to be flat in such a way as to be easily sandwiched by the plate-like elements 780. The light receiving unit 74-1 is arranged in an annular shape in accordance with a light collecting region of the ball lens 71 in such a way as to be able to receive the spatial optical signal to be received. The light receiving unit 74 is formed on the substrate 740-1. The light receiving unit 74 is connected to the control device (not illustrated) and the transmitter 7701 by a conductive wire 78. The color filter 790-1 is arranged on a side surface of the cylindrical light receiver 7101. The color filter 790-1 removes unnecessary light and selectively transmits the spatial optical signal used for communication. The pair of plate-like elements 780 are arranged on upper and lower surfaces of the cylindrical light receiver 7101. The pair of plate-like elements sandwich the ball lens 71 from above and below. The light receiving unit 74 formed in an annular shape is arranged on an emission side of the ball lens 71. The spatial optical signal incident on the ball lens 71 through the color filter 790-1 is collected on the light receiving unit 74-1 by the ball lens 71. The control device (not illustrated) causes the transmitter 7701 to transmit the spatial optical signal according to the optical signal received by the light receiving unit 74-1. The transmitter 7701 can be implemented by the configuration in FIG. 31. The transmitter 7701 has a slit formed in such a way that the spatial optical signal can be projected in a direction of 360 degrees.

There are few obstacles on an upper portion of a pole such as a utility pole or a street lamp. Therefore, the upper portion of the pole such as a utility pole or a street lamp is suitable for installing the communication device 700-1. In addition, in a case where the communication devices 700-1 are installed at the same height on the upper portions of the poles, the arrival direction of the spatial optical signal is limited to the horizontal direction, so that a light receiving area of the light receiving unit 74-1 included in the light receiver 7101 can be reduced, and thus, device simplification can be achieved. A pair of communication devices 700-1 that perform communication with each other are arranged in such a way that at least one communication device 700-1 receives the spatial optical signal transmitted from the other communication device 700-1. The pair of communication devices 700-1 may be arranged to transmit and receive the spatial optical signal to and from each other. In a case where the communication network for the spatial optical signal includes the plurality of communication devices 700-1, it is sufficient if the communication device 700-1 positioned in the middle is arranged to relay the spatial optical signal transmitted from one communication device 700-1 to another communication device 700-1.

According to the present application example, communication using the spatial optical signal can be performed among the plurality of communication devices 700-1 installed on different poles. For example, wireless communication may be performed between a wireless device or a base station installed in an automobile, a house, or the like and the communication device 700-1 according to communication between the communication devices 700-1 installed on different poles. For example, the communication device 700-1 may be configured to be connected to the Internet via a communication cable or the like installed on the pole.

### Application Example 2

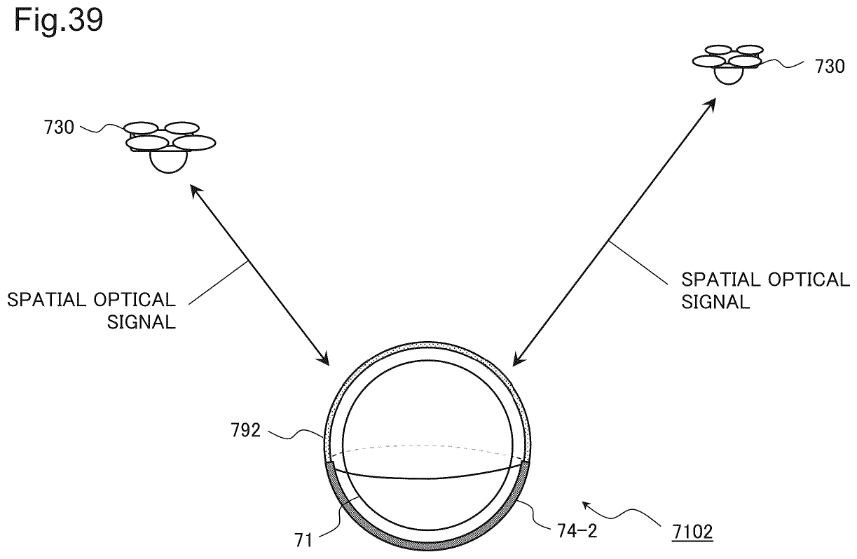

Next, Application Example 2 of the communication device according to the present example embodiment will be described with reference to the drawings. FIG. 39 is a conceptual view for explaining the present application example. The communication device of the present application example transmits and receives a spatial optical signal to and from a drone 730 flying in the sky. In FIG. 39, the spatial optical signal is transmitted from the drone 730 flying in the sky to the communication device (light receiver 7102) installed on the ground. In the following description, it is assumed that the drone 730 can transmit and receive the spatial optical signal. The drone 730 can fly at any position in the sky. Therefore, the light receiver 7102 is configured to be able to receive the spatial optical signals arriving from all directions in the sky. In the example of FIG. 39, configurations of a transmission device (transmitter), a reception circuit, a control device, and the like are omitted.

The light receiver 7102 includes a ball lens 71, a light receiving unit 74-2, and a color filter 790-2. The light receiving unit 74-2 is arranged in an annular shape with a light receiving surface facing upward in accordance with a light collecting region of the ball lens 71 in such a way as to be able to receive the spatial optical signal transmitted from the drone 730. An upper portion (incident surface side) of the ball lens 71 is covered with the spherical color filter 790-2. The color filter 790-2 removes unnecessary light and selectively transmits the spatial optical signal used for communication. The light receiving unit 74-2 formed along the spherical surface is arranged below (on an emission side of) the ball lens 71. The spatial optical signal incident on the ball lens 71 through the color filter 790-2 is collected on the light receiving unit 74-2 by the ball lens 71. For example, the control device (not illustrated) may cause the transmission device (not illustrated) to transmit the spatial optical signal toward the drone 730 according to the optical signal received by the light receiving unit 74-2.

According to the present application example, communication using the spatial optical signal can be performed between the drone 730 that flies at an arbitrary position in the sky and the communication device installed on the ground. For example, a system that utilizes information acquired by the drone 730 in real time when the communication device is connected to the Internet can be configured.

As described above, the communication device according to the present example embodiment includes the reception device according to any one of the first to sixth example embodiments, the transmission device, and the control device. The transmission device transmits the spatial optical signal under the control of the control device. The control device receives a signal based on an optical signal from another communication device received by the reception device. The control device executes processing according to the received signal. The control device causes the transmission device to transmit the spatial optical signal associated to the executed processing. According to the present example embodiment, it is possible to implement a communication device that transmits and receives an optical signal.

A communication system according to an aspect of the present example embodiment includes a plurality of communication devices arranged to transmit and receive an optical signal to and from each other. According to this aspect, it is possible to implement a communication network that transmits and receives an optical signal.

A reception device according to an aspect of the present example embodiment includes a ball lens and a plurality of light receiving units. The ball lens collects an optical signal propagating in a space. The plurality of light receiving units each include a light receiving element array and a reception circuit. The light receiving element array includes the plurality of light receiving elements that receive optical signals collected by the ball lens. The light receiving element array outputs signals derived from the optical signals received by the plurality of light receiving elements. The reception circuit decodes the signals output from the light receiving element array. The plurality of light receiving units are arranged in a light collecting region of the ball lens in such a way that light receiving surface face the ball lens. For example, the plurality of light receiving units are arranged in accordance with an arrival direction of the optical signal. The reception device according to this aspect has a configuration in which a plurality of light receiving units are associated with a single ball lens. According to this aspect, it is possible to construct a communication system in which the communication device can be flexibly arranged by changing an orientation of a light receiving portion of the light receiving unit according to the arrival direction of the optical signal.

### Eighth Example Embodiment

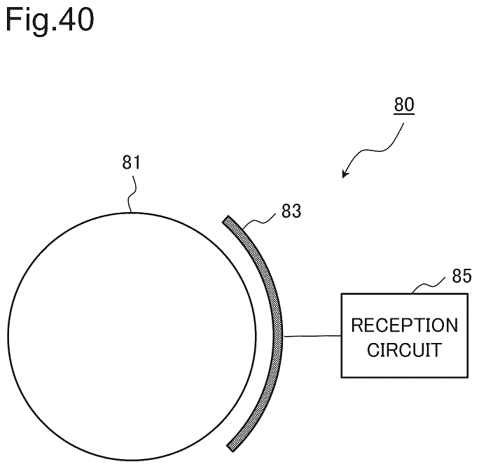

Next, a reception device according to an eighth example embodiment will be described with reference to the drawings. The reception device according to the present example embodiment has a configuration in which the reception devices of the first to seventh example embodiments are simplified. FIG. 40 is a conceptual view illustrating an example of a configuration of a reception device 80 according to the present example embodiment. The reception device 80 includes a ball lens 81, a light receiving element array 83, and a reception circuit 85.

The ball lens 81 collects an optical signal propagating in a space. The light receiving element array 83 includes a plurality of light receiving elements (not illustrated) that receive optical signals collected by the ball lens 81. The light receiving element array 83 outputs signals derived from the optical signals received by the plurality of light receiving elements. The reception circuit 85 decodes the signals output from the light receiving element array.

In the reception device according to the present example embodiment, a plurality of receiving elements receive optical signals collected by the ball lens. The ball lens uniformly collects a spatial optical signal arriving from any direction in the surrounding light collecting region. Therefore, according to the present example embodiment, optical signals arriving from various directions can be uniformly received with a simple configuration.

### (Hardware)

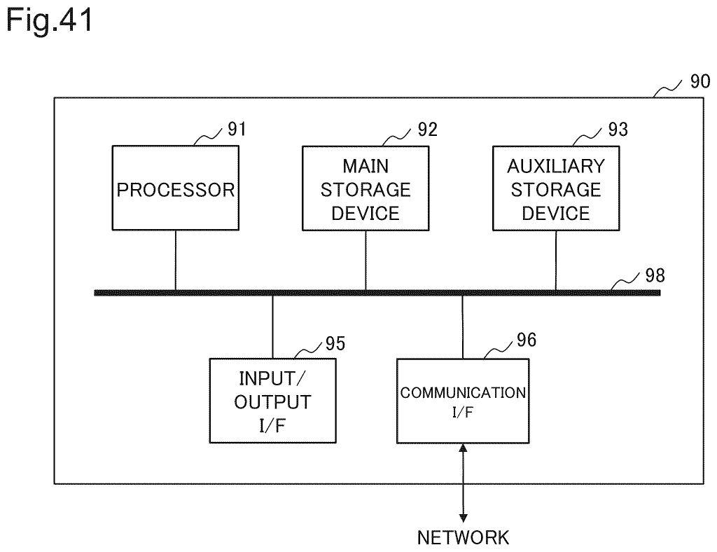

Here, a hardware configuration for executing control and processing according to each example embodiment of the present disclosure will be described using an information processing device 90 in FIG. 41 as an example. The information processing device 90 in FIG. 41 is a configuration example for executing the control and processing according to each example embodiment, and does not limit the scope of the present disclosure.

As illustrated in FIG. 41, the information processing device 90 includes a processor 91, a main storage device 92, an auxiliary storage device 93, an input/output interface 95, and a communication interface 96. In FIG. 41, the interface is abbreviated as an I/F. The processor 91, the main storage device 92, the auxiliary storage device 93, the input/output interface 95, and the communication interface 96 are data-communicably connected to each other via a bus 98. In addition, the processor 91, the main storage device 92, the auxiliary storage device 93, and the input/output interface 95 are connected to a network such as the Internet or an intranet via the communication interface 96.

The processor 91 loads a program stored in the auxiliary storage device 93 or the like to the main storage device 92. The processor 91 executes the program loaded to the main storage device 92. In the present example embodiment, it is sufficient if a software program installed in the information processing device 90 is used. The processor 91 executes the control and processing according to each example embodiment.

The main storage device 92 has a region to which the program is loaded. A program stored in the auxiliary storage device 93 or the like is loaded to the main storage device 92 by the processor 91. The main storage device 92 may be implemented by a volatile memory such as a dynamic random access memory (DRAM). A nonvolatile memory such as a magneto resistive random access memory (MRAM) may be configured and added as the main storage device 92.

The auxiliary storage device 93 stores various pieces of data such as programs. The auxiliary storage device 93 is implemented by a local disk such as a hard disk or a flash memory. Various pieces of data may be stored in the main storage device 92, and the auxiliary storage device 93 may be omitted.

The input/output interface 95 is an interface for connecting the information processing device 90 and a peripheral device based on a standard or a specification. The communication interface 96 is an interface for connecting to an external system or device through a network such as the Internet or an intranet based on a protocol or a specification. The input/output interface 95 and the communication interface 96 may be shared as an interface connected to an external device.

An input device such as a keyboard, a mouse, or a touch panel may be connected to the information processing device 90 as necessary. These input devices are used to input information and settings. In a case where the touch panel is used as the input device, a display screen of a display device may also serve as the interface of the input device. Data communication between the processor 91 and the input device may be performed via the input/output interface 95.

The information processing device 90 may be provided with a display device for displaying information. In a case where the display device is provided, the information processing device 90 may include a display control device (not illustrated) for controlling display of the display device. The display device may be connected to the information processing device 90 via the input/output interface 95.

Further, the information processing device 90 may be provided with a drive device. The drive device mediates, for example, reading of data and a program from a recording medium and writing of a processing result of the information processing device 90 to the recording medium between the processor 91 and the recording medium (program recording medium). The drive device may be connected to the information processing device 90 via the input/output interface 95.

An example of the hardware configuration for executing the control and processing according to each example embodiment of the present invention has been described above. The hardware configuration in FIG. 41 is an example of the hardware configuration for executing the control and processing according to each example embodiment, and does not limit the scope of the present invention. In addition, a program for causing a computer to execute the control and processing according to each example embodiment also falls within the scope of the present invention. Further, a program recording medium having the program according to each example embodiment recorded therein also falls within the scope of the present invention. The recording medium can be implemented by, for example, an optical recording medium such as a compact disc (CD) or a digital versatile disc (DVD). The recording medium may be implemented by a semiconductor recording medium such as a universal serial bus (USB) memory or a secure digital (SD) card. Furthermore, the recording medium may be implemented by a magnetic recording medium such as a flexible disk, or another recording medium. In a case where the program executed by the processor is recorded in a recording medium, the recording medium corresponds to the program recording medium.

Any combination of the components of each example embodiment is possible. In addition, the components of each example embodiment may be implemented by software or may be implemented by a circuit.

While the present invention has been particularly shown and described with reference to the example embodiments thereof, the present invention is not limited to these example embodiments. It will be understood by those of ordinary skill in the art that various changes in form and details may be made therein without departing from the spirit and scope of the present invention as defined by the claims.

Some or all of the above-described example embodiments can also be described as the following Supplementary Notes, but are not limited thereto.

### Supplementary Note 1

A reception device including:
a ball lens that collects an optical signal propagating in a space;
a light receiving element array that includes a plurality of light receiving elements that each receive the optical signal collected by the ball lens and outputs a signal derived from the optical signal received by each of the plurality of light receiving elements; and a reception circuit that decodes the signal output from the light receiving element array.

### (Supplementary Note 2)

The reception device according to Supplementary Note 1, in which the light receiving element array includes the plurality of light receiving elements arranged in an arc shape in a circumferential direction of the ball lens in a light collecting region of the ball lens.

### (Supplementary Note 3)

The reception device according to Supplementary Note 1 or 2, in which at least one light receiving element array is arranged in accordance with an arrival direction of the optical signal.

### (Supplementary Note 4)

The reception device according to any one of Supplementary Notes 1 to 3, in which the light receiving element array includes the plurality of light receiving elements arranged in a two-dimensional array in the circumferential direction of the ball lens in the light collecting region of the ball lens.

### (Supplementary Note 5)

The reception device according to any one of Supplementary Notes 1 to 4, in which the light receiving element array includes the plurality of light receiving elements arranged in an annular shape in such a way as to surround the ball lens in the light collecting region of the ball lens.

### (Supplementary Note 6)

The reception device according to any one of Supplementary Notes 1 to 5, further including an optical element that is arranged between the ball lens and the light receiving element array and guides the optical signal collected by the ball lens toward a light receiving portion of any one of the light receiving elements included in the light receiving element array.

### (Supplementary Note 7)

The reception device according to Supplementary Note 6, in which the optical element is a cylindrical lens bent in an arc shape with a flat surface side facing outward in the circumferential direction of the ball lens, collects the optical signal collected by the ball lens in a direction orthogonal to an arrangement direction of the light receiving element array, and guides the optical signal to the light receiving portion of any one of the light receiving elements included in the light receiving element array.

### (Supplementary Note 8)

The reception device according to Supplementary Note 6, in which the optical element includes a diffractive optical element bent in an arc shape in the circumferential direction of the ball lens, diffracts the optical signal collected by the ball lens in a direction orthogonal to an arrangement direction of the light receiving element array, and guides the optical signal to the light receiving portion of any one of the light receiving elements included in the light receiving element array.

### (Supplementary Note 9)

The reception device according to Supplementary Note 6, in which the optical element includes a diffusion plate bent in an arc shape in the circumferential direction of the ball lens, diffuses the optical signal collected by the ball lens, and guides the optical signal to the light receiving portion of any one of the light receiving elements included in the light receiving element array.

### (Supplementary Note 10)

The reception device according to any one of Supplementary Notes 1 to 9, further including a reflection structure that is arranged in a non-sensitive region of each of the plurality of light receiving elements and reflects the optical signal emitted from the ball lens toward the light receiving portion of the light receiving element.

### (Supplementary Note 11)

A communication device including:
the reception device according to any one of Supplementary Notes 1 to 10;
a transmission device that transmits an optical signal; and
a control device that receives a signal based on an optical signal from another communication device received by the reception device, executes processing according to the received signal, and causes the transmission device to transmit an optical signal associated to the executed processing.

### (Supplementary Note 12)

A communication system including:
a plurality of the communication devices according to Supplementary Note 11,
in which the plurality of communication devices are arranged to transmit and receive an optical signal to and from each other.

### (Supplementary Note 13)

The communication system according to Supplementary Note 12, in which the reception device includes:
the ball lens that collects the optical signal propagating in a space; and
a plurality of light receiving units that each include the light receiving element array that includes the plurality of light receiving elements that each receive the optical signal collected by the ball lens and outputs a signal derived from the optical signal received by each of the plurality of light receiving elements, and the reception circuit that decodes the signal output from the light receiving element array, and
the plurality of light receiving units are arranged in the light collecting region of the ball lens in such a way that light receiving surfaces face the ball lens.

### (Supplementary Note 14)

The communication system according to Supplementary Note 13, in which the plurality of light receiving units are arranged in accordance with the arrival direction of the optical signal.

### REFERENCE SIGNS LIST

1, 2, 3, 4, 5, 6 Reception device
10, 20, 30, 40, 50, 60, 70 Light receiver
11, 21, 31, 41, 51, 61, 71 Ball lens
13, 23, 33, 43, 53, 63 Light receiving element array
15, 25, 35, 45, 55, 65 Reception circuit
37, 47, 57 Optical element
74 Light receiving unit
110 Light source
130, 330, 430, 530 Substrate
131, 231, 331, 431, 531, 631 Light receiving element
132, 332, 432, 532, 632 Light receiving portion
151 First processing circuit
152 Control circuit
153 Selector
155 Second processing circuit
200 Substrate
471 First diffraction portion
472 Second diffraction portion
473 Third diffraction portion
474 Fourth diffraction portion
475 Transparent portion
571 First diffusion portion
572 Second diffusion portion
575, 576 Transparent portion
636 reflection structure
700 Communication device
710 Reception device
740 Substrate
750 Control device
770 Transmission device
771 Light source
773 Spatial light modulator
7730 Modulation portion

What is claimed is:

1. A reception device comprising:
a ball lens that collects an optical signal propagating in a space;
a light receiving element array that includes a plurality of light receiving elements that each receive the optical signal collected by the ball lens and outputs a signal derived from the optical signal received by each of the plurality of light receiving elements; and
a reception circuit that decodes the signal output from the light receiving element array.

2. The reception device according to claim 1, wherein
the light receiving element array includes the plurality of light receiving elements arranged in an arc shape in a circumferential direction of the ball lens in a light collecting region of the ball lens.

3. The reception device according to claim 1, wherein
at least one light receiving element array is arranged in accordance with an arrival direction of the optical signal.

4. The reception device according to claim 1, wherein the light receiving element array includes the plurality of light receiving elements arranged in a two-dimensional array in the circumferential direction of the ball lens in the light collecting region of the ball lens.

5. The reception device according to claim 1, wherein
the light receiving element array includes the plurality of light receiving elements arranged in an annular shape in such a way as to surround the ball lens in the light collecting region of the ball lens.

6. The reception device according to claim 1, further comprising
an optical element that is arranged between the ball lens and the light receiving element array and guides the optical signal collected by the ball lens toward a light receiving portion of any one of the light receiving elements included in the light receiving element array.

7. The reception device according to claim 6, wherein
the optical element is a cylindrical lens bent in an arc shape with a flat surface side facing outward in the circumferential direction of the ball lens, collects the optical signal collected by the ball lens in a direction orthogonal to an arrangement direction of the light receiving element array, and guides the optical signal to the light receiving portion of any one of the light receiving elements included in the light receiving element array.

8. The reception device according to claim 6, wherein
the optical element includes a diffractive optical element bent in an arc shape in the circumferential direction of the ball lens, diffracts the optical signal collected by the ball lens in a direction orthogonal to an arrangement direction of the light receiving element array, and guides the optical signal to the light receiving portion of any one of the light receiving elements included in the light receiving element array.

9. The reception device according to claim 6, wherein
the optical element includes a diffusion plate bent in an arc shape in the circumferential direction of the ball lens, diffuses the optical signal collected by the ball lens, and guides the optical signal to the light receiving portion of any one of the light receiving elements included in the light receiving element array.

10. The reception device according to claim 1, further comprising
a reflection structure that is arranged in a non-sensitive region of each of the plurality of light receiving elements and reflects the optical signal emitted from the ball lens toward the light receiving portion of the light receiving element.

11. A communication device comprising:
the reception device according to claim 1;
a transmission device that transmits an optical signal; and
a controller comprising
a memory storing instructions, and
a processor connected to the memory and configured to execute the instructions to
receive a signal based on an optical signal from another communication device received by the reception device,
execute processing according to the received signal, and
cause the transmission device to transmit an optical signal associated to the executed processing.

12. A communication system comprising:
a plurality of the communication devices according to claim 11, wherein
the plurality of communication devices are arranged to transmit and receive an optical signal to and from each other.

13. The communication system according to claim 12, wherein the reception device includes:
a ball lens that collects the optical signal propagating in a space; and
a plurality of light receiving units that each include the light receiving element array that includes a plurality of light receiving elements that each receive the optical signal collected by the ball lens and outputs a signal derived from the optical signal received by each of the plurality of light receiving elements, and a reception circuit that decodes the signal output from the light receiving element array, wherein the plurality of light receiving units are arranged in a light collecting region of the ball lens in such a way that light receiving surfaces face the ball lens.

14. The communication system according to claim 13, wherein
the plurality of light receiving units are arranged in accordance with an arrival direction of the optical signal.
